(19) United States
(12) Patent Application Publication
(10) Pub. No.: US 2023/0162111 A1
(43) Pub. Date: May 25, 2023

(54) RATE CARD MANAGEMENT

(71) Applicant: Indigo Ag, Inc., Boston, MA (US)

(72) Inventors: Amit Menipaz, Los Gatos, CA (US); Fernando Tubilla, Milton, MA (US); Misha Sidorsky, Cambridge, MA (US); John Richard Hunter, Boston, MA (US); Kearney Klein, Allentown, PA (US); Andrew A. Luther, Boston, MA (US); Nick Kabrich, Scottsdale, AZ (US); Adam Conrad, Dover, MA (US); Jason Davis-Cooke, Melrose, MA (US); Jordan Lee Pollard, Needham, MA (US)

(21) Appl. No.: 18/051,798

(22) Filed: Nov. 1, 2022

Related U.S. Application Data
(63) Continuation of application No. PCT/US2021/030243, filed on Apr. 30, 2021.
(60) Provisional application No. 63/019,122, filed on May 1, 2020.

(51) Int. Cl. G06Q 10/0631; G06Q 10/0835; G06Q 30/0283

(52) U.S. Cl. CPC G06Q 10/063118; G06Q 10/08355; G06Q 30/0284

(57) ABSTRACT

Computationally efficient management of location-dependent values, such as rate cards, is provided, for example in the context of transport and market systems. A ball tree is traversed. The ball tree comprises a plurality of nodes, each node of the ball tree comprising a pivot geographic location and a radius, each node corresponding to at least one local value having a location within the radius of the pivot. Traversing the ball tree comprises: computing a bound on the location-dependent value for at least one node of the ball tree based on its corresponding at least one local value, its pivot geographic location, and a first geographic location, selectively traversing at least one child of the at least one node according to the bound, computing the location-dependent value for the at least one child based on its corresponding at least one local value, its pivot geographic location, and the first geographic location, and inserting the location dependent value of the at least one child to a sorted collection having a predetermined size.

### CROSS-REFERENCE TO RELATED APPLICATIONS

This application is a continuation of International Application No. PCT/US2021/030243, filed Apr. 30, 2021, which claims the benefit of U.S. Provisional Application No. 63/019,122, filed May 1, 2020, each of which is hereby incorporate by reference in its entirety.

### BACKGROUND

Transportation providers, carriers and individual owner operators providing transportation of freight, are accustomed to two methods of scheduling work. In one method, they engage in flexible and dynamic spot quoting and negotiation process, where they determine the value of an individual, near-term job opportunity by searching multiple online job boards and separately tracking relevant opportunities presented in these different forums, contacting companies in need of transportation services, and individually negotiating the terms under which they will provide transportation services for each opportunity. Using this method, transportation providers can often source competitive quotes to secure work on a week by week basis, but this process is time-consuming and doesn't offer reliability or stability of work. In the second method, transportation providers identify and negotiate rigid, long-term contracts with a single partner often to provide transportation services over an extended period of time, often an entire year. This method offers reliability and ease of planning, but at significant opportunity cost; transportation providers are unable to adjust rates with changing market conditions or acquire more profitable spot business throughout the year.

The methods and interfaces of the present disclosure address the technical challenges with existing online methods of managing transportation services. In various embodiments of the present disclosure, transportation providers use a single interface presented on an electronic device, such as a computer or phone, within which the user can input parameters of actionable jobs based on current demand information and automatically secure relevant jobs.

### BRIEF SUMMARY

According to embodiments of the present disclosure, methods of and computer program products for sorting location-dependent values are provided. A first geographic location is read. A ball tree is traversed. The ball tree comprises a plurality of nodes, each node of the ball tree comprising a pivot geographic location and a radius, each node corresponding to at least one local value having a location within the radius of the pivot. Traversing the ball tree comprises: computing a bound on the location-dependent value for at least one node of the ball tree based on its corresponding at least one local value, its pivot geographic location, and the first geographic location, selectively traversing at least one child of the at least one node according to the bound, computing the location-dependent value for the at least one child based on its corresponding at least one local value, its pivot geographic location, and the first geographic location, and inserting the location dependent value of the at least one child to a sorted collection having a predetermined size.

In some embodiments, the first geographic location corresponds to a grower.

In some embodiments, the location of each local value corresponds to a delivery location. In some embodiments, each local value correspond to a bid.

In some embodiments, the location-dependent value is a basis net of transport. In some embodiments, computing the bound on the location dependent-value comprises subtracting a product of an estimated freight rate and an estimated distance between the first geographic location and the location of one of the local values from that local value. In some embodiments, the estimated freight rate is an estimated lower bound on an actual freight rate. In some embodiments, the estimated distance is a haversine distance. In some embodiments, selectively traversing comprises traversing the at least one child when the bound is greater than or equal to a least value in the collection. In some embodiments, computing the location-dependent value comprises subtracting a product of an actual freight rate and an actual distance between the first geographic location and the location of one of the local values from that local value.

According to embodiments of the present disclosure, a non-transitory computer readable medium comprising instructions embodied therewith is provided, the program instructions executable by a processor to cause the processor to instantiate a ball tree. The ball tree comprises a plurality of non-leaf nodes, each of the plurality of non-leaf nodes comprising a geographical pivot point, a radius, and a reference to at least one child node. The ball tree comprises a plurality of leaf nodes, each of the plurality of leaf nodes being a child of exactly one non-leaf node, each of the plurality of leaf nodes comprising a geographical pivot point, a radius, and at least one local value having a location within the radius of the pivot of its leaf node.

In some embodiments, the location of each local value corresponds to a delivery location. In some embodiments, each local value corresponds to a bid.

According to embodiments of the present disclosure, a system is provided. The system comprises a first computing node configured to perform any of the methods of sorting location-dependent values as set forth above. The system comprises a second computing node comprising a spatial index of a plurality of rate cards, each rate card comprising the actual freight rate. Computing the location-dependent value comprises requesting a rate card from the spatial index according to the first geographic location and the location of the at least one local value.

In some embodiments, the spatial index comprises an R-tree or a k-d tree.

According to embodiments of the present disclosure, an interface for automated real-time rate card management is provided. The interface comprises, within a screen of a transportation provider client device: a map region comprising a user-defined first region having non-zero area contained within the map region, one or more real-time market demand elements associated with a user-defined region, a user-editable field containing a base rate for transportation services within the first region calculated automatically upon generation of the first region, a second user defined region having non-zero area fully-contained within the first region, a user-editable expiration date field, and one or more user-editable adjustments fields, where at least one of the one or more adjustments are selected from the list consisting of a seasonal adjustment, an origin adjustment, a destination adjustment, a lead time adjustment, and a quantity adjustment.

In some embodiments, the interface additionally comprises a third user defined region having non-zero area fully-contained within the first region. In some embodiments, the second region is an origin zone and the third region is a destination zone. In some embodiments, the origin zone and the destination zone are a lane. In some embodiments, the user-editable expiration date field and one or more user-editable adjustments fields contain values associated with the lane.

In some embodiments, the one or more user-editable adjustments fields are generated automatically based on the creation of the first user defined region or the second user defined region.

In some embodiments, the interface additionally comprises a plurality of user defined regions fully contained within the first region.

In some embodiments, the one or more user-defined region is a circle of a user-defined radius around a position within the map region.

In some embodiments, the one or more user-defined region is a shape drawn on map region by the user.

In some embodiments, at least one of the one or more real-time market demand elements are selected from the list consisting of a map layer colored proportionally to market demand, a number of transportation opportunities within one or more user-defined regions, a number or location of transportation opportunities matching user's rate within one or more user-defined regions, a number or location of transportation opportunities within one or more user-defined regions matching the rate of a transportation provider other than the user, a proportion of opportunities within one or more user-defined regions meeting one or more rate parameters, detail of one or more potential transactions within one or more user-defined regions, locations of one or more potential transactions, a number times a user's rate has previously been awarded, a number of goods listed for sale within one or more user-defined regions, and a number of other transportation providers' bids to provide transportation services within one or more user-defined regions.

In some embodiments, the interface additionally comprises a user-editable field for the minimum or maximum number of loads per week.

In some embodiments, the second region is a local zone, an origin zone, or a destination zone.

In some embodiments, the interface additionally comprises display of one or more routes within the map region, wherein the displayed one or more routes begin in the second region, end in the second region, or begin and end in the second region. In some embodiments, selection via clicking or tapping the displayed route automatically executes an agreement to provide transportation services. In some embodiments, the display of one or more routes includes one or more descriptors for each route selected from the list consisting of a price per mile, a total distance, a commodity type, delivery window, and quantity of goods to be transported.

In some embodiments, the one or more real-time market demand elements is updated in real-time for the first user defined region, the second user defined region, or all user defined regions.

In some embodiments, the one or more real-time market demand elements is updated in real-time for the lane.

According to embodiments of the present disclosure, any of the systems as described above further comprise a transportation provider client device configured to provide any of the interfaces described above. The transportation provider client device is configured to provide rate cards to the second computing node for inclusion in the spatial index.

According to embodiments of the present disclosure, methods and computer program products for automated real-time rate card management are provided. A request to provide transportation services is received from each of a plurality of transportation providers. A map region is displayed on an interface of a client device of each transportation provider. A first region having non-zero area within the map region is received from each transportation provider via their client device. A base rate is calculated for providing transportation services within each transportation provider first region and modifying the interface of each transportation provider to display the base rate in a field editable by each transportation provider. A second region having non-zero area contained within the first region is received from each transportation provider via their client device. The interface of each client device is modified to display a real-time indication of market demand within each transportation provider's second region. In response to receiving the second regions, one or more user editable fields are generated within each interface of a client device of each transportation provider. The fields include an expiration date field, and one or more adjustment fields, where at least one of the one or more adjustment fields are selected from the list consisting of a seasonal adjustment, an origin adjustment, a destination adjustment, a lead-time adjustment, and a quantity adjustment. A transportation services opportunity is received comprising an origin location, a destination location, a price of a good to be transported, and a delivery window. The set of the transportation providers' requests is determined wherein the origin location or destination location of the transportation services opportunity are within the transportation providers' second regions and the transportation providers' expiration date are not before the beginning of the delivery window. For each transportation providers' request within the set, a custom rate is calculated to provide transportation services for the transportation services opportunity based on each transportation providers requests' base rate and adjustments. In real-time an interface of a user of an online crop transaction system is updated with the price of a good to be transported less the cost to transport that good at the lowest calculated custom rate of the transportation providers' request within the set.

In some embodiments, the interface of a client device of each transportation provider is any of the interfaces as described above.

In some embodiments, the transportation services opportunity additionally comprises a quantity of a good to be transported.

In some embodiments, determining the price of the good to be transported less the cost to transport that good is determined according to any of the methods of sorting location-dependent values as described above.

### BRIEF DESCRIPTION OF THE SEVERAL VIEWS OF THE DRAWINGS

FIGS. 1A-B illustrate methods by which a transportation provider utilizes online resources to obtain jobs.

FIG. 1C illustrates a method of rate card management according to embodiments of the present disclosure.

FIG. 2 illustrates portions of a user interface according to embodiments of the present disclosure.

FIG. 3 illustrates a portion of a user interface according to embodiments of the present disclosure.

FIG. 4 shows a portion of a user interface displaying an exemplary rate card according to embodiments of the present disclosure.

FIG. 5 shows a portion of a user interface showing a summary of rates according to embodiments of the present disclosure.

FIG. 6A shows various aspects of an exemplary representation of a rate card according to embodiments of the present disclosure.

FIG. 6B shows various aspects of an exemplary online crop transaction system according to embodiments of the present disclosure.

FIG. 7 shows an example of a transportation provider's user interface according to embodiments of the present disclosure.

FIG. 8 shows another example of a transportation provider's user interface according to embodiments of the present disclosure.

FIGS. 9A-B show additional examples of a transportation provider's user interface according to embodiments of the present disclosure.

FIG. 10 shows another example of a transportation provider's user interface according to embodiments of the present disclosure.

FIG. 11 shows another example of an interface of a user's device according to embodiments of the present disclosure.

FIG. 12 shows another example of an interface of a user's device according to embodiments of the present disclosure.

FIG. 13 shows another example of an interface in which a user may set parameters of actionable jobs according to embodiments of the present disclosure.

FIG. 14 shows another example of an interface according to embodiments of the present disclosure.

FIG. 15 shows an example of a user interface where a user may search for a destination and origin location according to embodiments of the present disclosure.

FIG. 16 shows an example of a user interface containing user defined regions according to embodiments of the present disclosure.

FIG. 17 shows an example of a rate setting dialog box according to embodiments of the present disclosure.

FIG. 18 shows exemplary real-time market demand elements according to embodiments of the present disclosure.

FIG. 19 illustrates an additional example of a portion of a user interface according to embodiments of the present disclosure.

FIG. 20 illustrates another example of a user interface of a transportation provider according to embodiments of the present disclosure.

FIG. 21 shows another example of a user interface comprising a user rate summary according to embodiments of the present disclosure.

FIG. 22 illustrates another example of a user interface of client device of a transportation provider according to embodiments of the present disclosure.

FIG. 23 illustrates an exemplary rate setting display area according to embodiments of the present disclosure.

FIG. 24 illustrates an example of a rate setting display area and a map display area according to embodiments of the present disclosure.

FIG. 25 shows an example of a user interface with market demand elements according to embodiments of the present disclosure.

FIG. 26 is a block diagram of a system environment for a goods transaction system and a transportation management system according to embodiments of the present disclosure.

FIG. 27 shows an example of participants' interactions according to embodiments of the present disclosure.

FIG. 28 illustrates a method for automated real-time rate card management according to embodiments of the present disclosure.

FIG. 29 illustrates an exemplary system for determining location-dependent values such as a FOB basis according to embodiments of the present disclosure.

FIG. 30 is a plot of the distance to the Nth best bid for a random sample of ZIP codes.

FIG. 31 is a schematic diagram of a node of a decorated ball tree according to embodiments of the present disclosure.

FIG. 32 illustrates steps to generate a ball tree according to embodiments of the present disclosure.

FIG. 33 illustrates the first 4 levels of an exemplary ball tree in Euclidean space according to embodiments of the present disclosure.

FIG. 34 is a box plot showing the number of lane quotes and service calls for an exemplary search according to embodiments of the present disclosure.

FIG. 35 is a box plot of various configurations of bids per leaf node and aggregated nodes per request according to embodiments of the present disclosure.

FIG. 36 is a box plot of lane quote and service calls in a warm start configuration according to embodiments of the present disclosure.

FIG. 37 shows an exemplary uniform distribution of actual freight rates according to embodiments of the present disclosure.

FIG. 38 is a box plot illustrating the number of lane quotes and service calls for exemplary lower bounds according to embodiments of the present disclosure.

FIG. 39 is a graph of average time relative to number of bids according to embodiments of the present disclosure.

FIG. 40 is a plot showing querying time and construction time as a function of the number of bids according to embodiments of the present disclosure.

FIG. 41 is a plot showing querying count as a function of the number of bids according to embodiments of the present disclosure.

FIG. 42 provides box plots of calls according to the number of total bids according to embodiments of the present disclosure.

FIG. 43 shows the origin and destination zones for a random sample of 500 rate cards according to embodiments of the present disclosure.

FIG. 44 provide graphs showing the time in milliseconds for retrieving the best matches for different numbers of lanes and rate cards per carrier according to embodiments of the present disclosure.

FIG. 45 illustrates a method of sorting location-dependent values according to embodiments of the present disclosure.

FIG. 46 depicts a computing node according to embodiments of the present disclosure.

### DETAILED DESCRIPTION

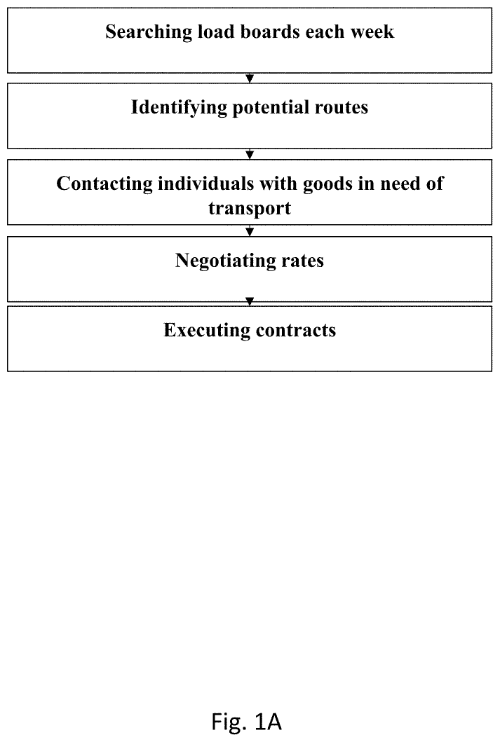

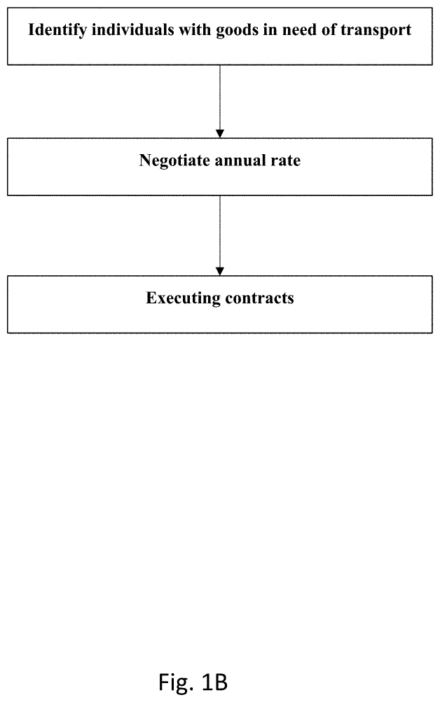

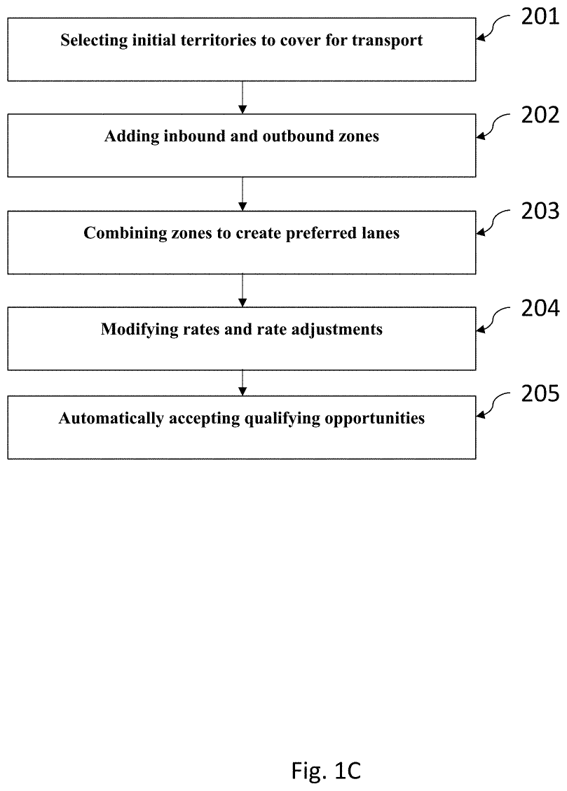

FIG. 1A shows a traditional method by which a transportation provider utilizes existing online resources to obtain jobs in the spot market. The method includes steps of searching multiple different online job boards each week, identifying potential routes, contacting the job by job basis. This process is time consuming, and the costs of switching between different online forums, often using different formats, are significant.

FIG. 1B shows another traditional method by which a transportation provider may secure jobs over a longer period of time. In this method the transportation provider identifies the individuals in needs of transportation services, and negotiates to provide transportation services for a period of time (often a season or year) for a single party. One challenge with this method is that transportation provider has no reliable method of receiving demand projections for the period of the contract while negotiating. And during the term of the contract transportation providers are unable to adjust rates with changing market conditions or acquire more profitable spot business.

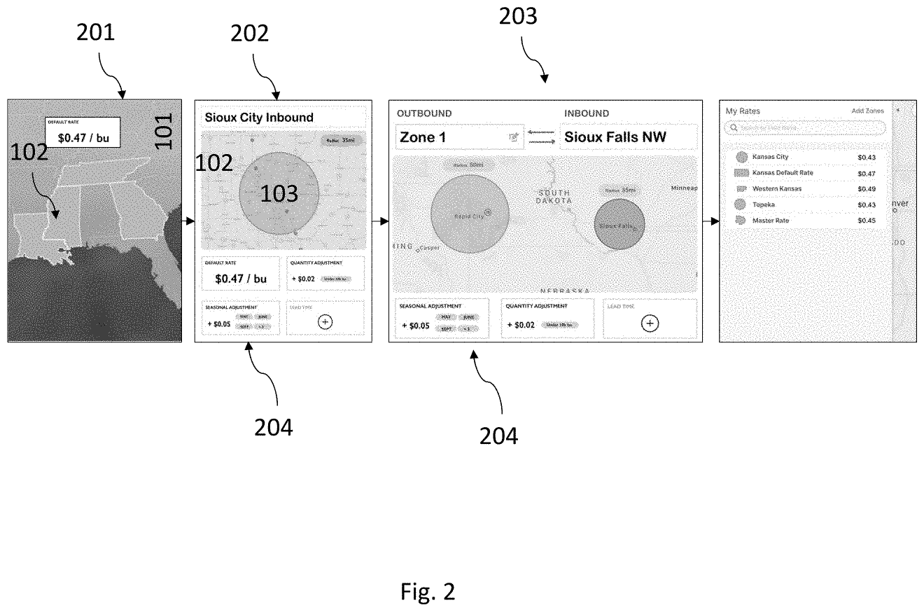

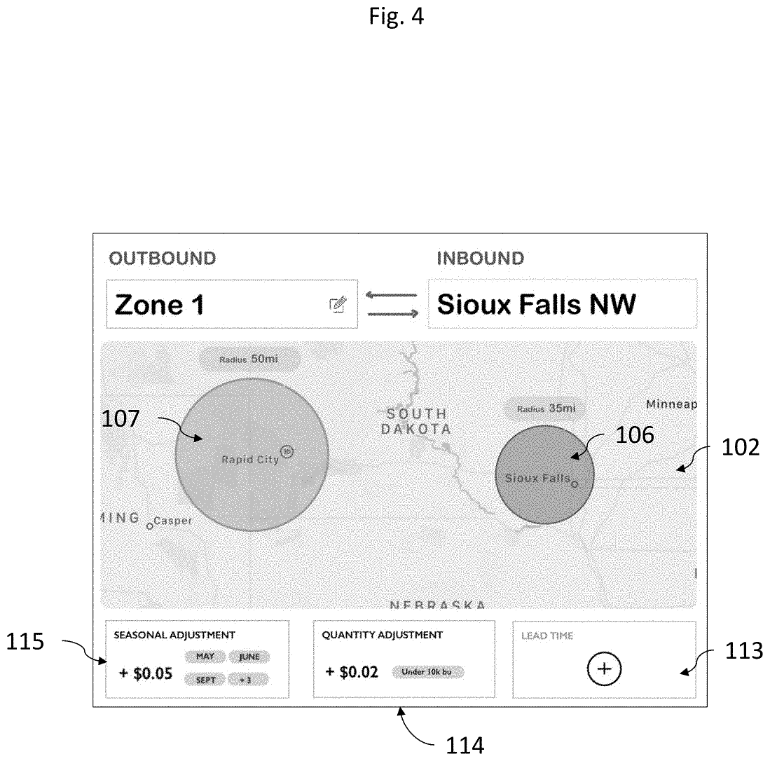

FIG. 1C shows one example of a method of the present disclosure. In the first step [201], a transportation provider selects, within the user interface of an electronic device, initial territories (alternately referred to as a first region) for which they will provide transportation services (for example see FIGS. 2 &7 [102]). In an additional step [202], the transportation provider may add one or more regions or locations located within the initial territory. In some embodiments, those regions are inbound zones (synonymously a destination zone) or outbound zones (synonymously an origin zone) (for example see FIGS. 4 [106] & [107]). An origin zone represents the geographic area within which the transportation provider agrees to start a route for freight transportation or pick-up product for transportation. A destination zone represents the geographic area within which the transportation provider agrees to deliver a product or end a route for freight transportation. The user may combine one or more zones to create a preferred lane, as shown by step [203]. A lane represents a region containing at least one origin location or zone and a least one destination location or zone. Optionally, a user may select one or more directions within a lane. The transportation provider may set or modify rates they will charge for transportation services within one or more regions they define, as shown by step [204]. If a request for transportation services (alternately a transportation opportunity) matches the current rate and parameters set by the transportation provider and the rate has not expired the transportation provider agrees to provide the services, as shown in step [205].

FIG. 2 shows another example of a method of the present disclosure, each panel illustrates a portion of a user interface. Step [201] is shown in the first panel, in which a user has selected a first region (alternately referred to as a territory) [102] within which they agree to provide transportation services from within the map region [101]. The second panel shows a portion of a user interface within which user has performed step [202] by defining an inbound zone. The second panel also shows that a user has performed step [204] by adding seasonal and quantity adjustments to the default rate in the illustrated zone [103]. The third panel shows that the user has performed step [203] by combining an inbound and outbound zone into a lane. The third panel also shows that a user has performed step [204] by adding seasonal and quantity adjustments to the lane. The fourth panel shows that the user has defined multiple regions.

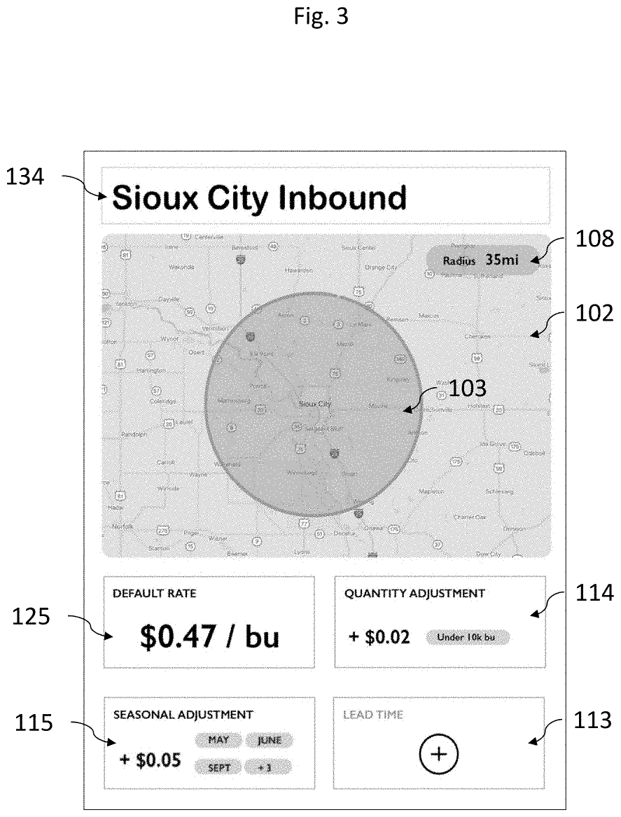

FIG. 3 shows various aspects of an exemplary rate card which may be shown within a user interface of the present disclosure. A rate card comprises at least one region and a rate, and has an associated effective period. Various geometries may be used to define the region, including a radius around a reference point, a polygon, or another regional definition known in the art. A rate may be given in any of a number of currencies, and may include additional metadata indicating the currency or other terms applied to the rate. The effective period may be given by a start date and end date within the rate card, just a start date, or just an end date. The effective period may also be implicit, in which case a rate card may be flagged as active when in effect and inactive when not in effect.

In this example a user has defined a rate name in the rate name field [134]. The user has defined a region [103] within a user defined territory [102]. The user defined region [103] is defined by a circular area having a radius of a number of miles set in a user determined radius field [108]. In this example the circular user defined region [103] is centered around the geographic location, Sioux City. The user interface additionally displays a user editable field containing the default rate [125] shown in dollars per bushel of commodity transported. Default rates may be quoted per unit or quantity of goods transported (for example, dollars per crate, cents per bushel or dollars per ton) or a price per mile of transportation (for example, cents per mile of transportation of cargo, or cents per mile with an empty truck). In some embodiments, a default rate may be a flat fee. The user interface contains a seasonal adjustment [115] to the default rate, in this example the seasonal adjustment is an additional premium of $0.05 per bushel relative to the default rate for transportation in the months of May, June, September and three other months not visible. The user interface also contains a quantity adjustment [114], in this example the quantity adjustment is a premium of $0.02 per bushel for jobs involving transportation of fewer than 10,000 bushels. The user interface also contains a user editable field for a lead time adjustment [113]. A lead time adjustment, like any adjustment may be a positive or negative value. In some embodiments, adjustments may be a monetary value per mile, a monetary value per unit or volume of good transported, a flat fee per trip, or a combination thereof.

FIG. 4 shows a portion of a user interface displaying an exemplary rate card for transportation service within a lane comprising an origin zone [107] and destination zone [106]. In this interface only a portion of the user defined territory [102] is shown, and it is displayed in a contrasting color (grey) to the origin zone [107] (green) and the destination zone [106] (red). In the interfaces of the present disclosure any colors or patterns may be used. Preferably such colors are visually appealing and of sufficient contrast for a user to readily distinguish the features they illustrate. This exemplary rate card does not display the default rate but does display seasonal [115] and quantity [114] adjustments and a user editable field for entry of a lead time adjustment [113].

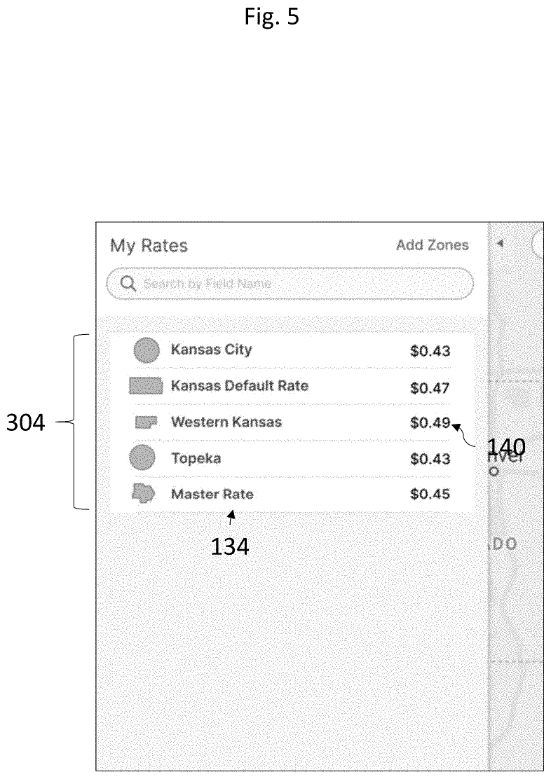

FIG. 5 shows a portion of a user interface showing a summary of rates set by a transportation provider. In this example the user rate summary [304] contains user defined rate names [134], a default rate, and a custom rate [140]. Custom rates are the sum of the default rate for the user defined region and all adjustments a user has applied to that region. A user rate summary may contain any combination of default or custom rates and may optionally include a small representation of the shape of one or more user defined regions. In some embodiments, the visual presentation of items displayed within a user rate summary is updated (periodically or in in real-time) based on a user or system defined factor, including without limitation factors such as changes in market demand for transportation services within a region, changes in market demand for commodities within a region, changes in weather, time until expiration of a rate, acceptance of a rate, award of a similar rate, and change in the number or dollar amount of other transportation providers setting rates for a region. In some embodiments, regions are automatically removed from a user rate summary after rates for those regions have expired.

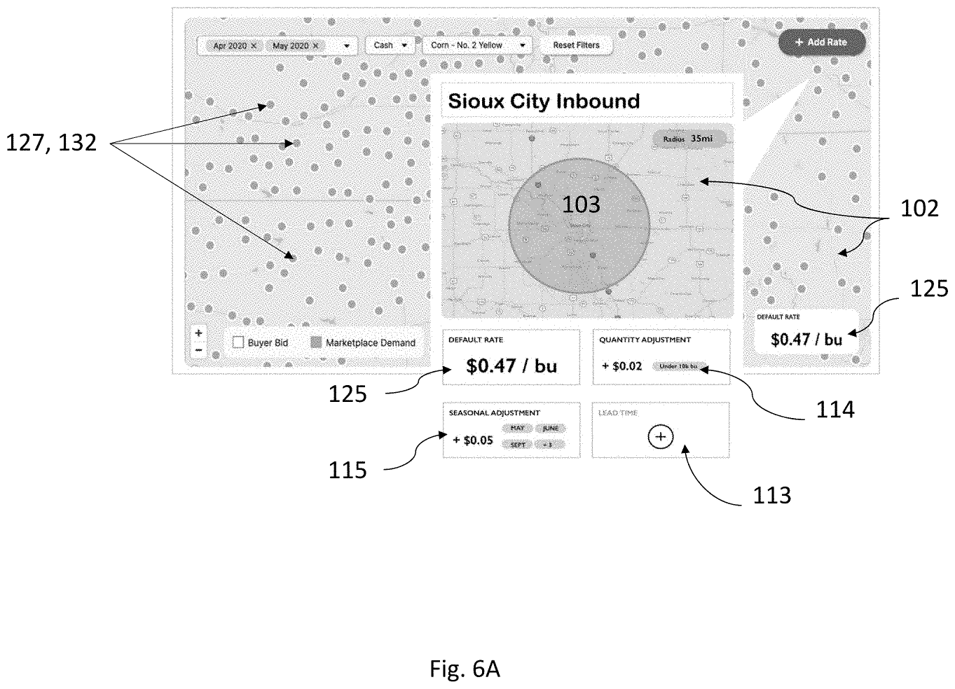

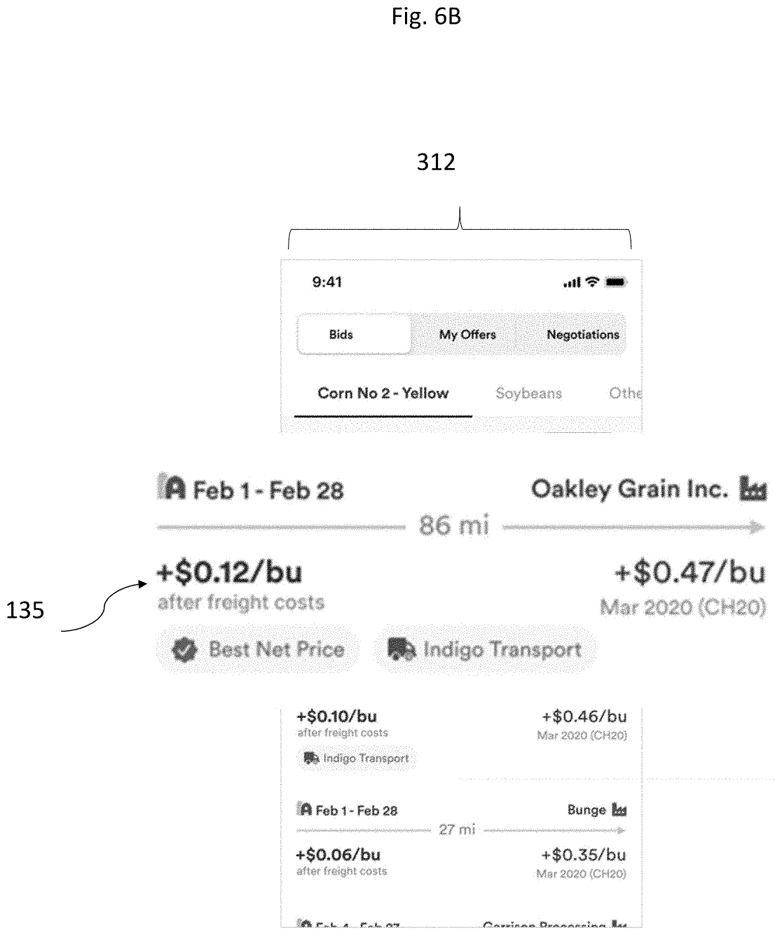

FIG. 6A shows various aspects of an exemplary representation of a rate card displayed within an embodiment of a user interface of the present disclosure. The user interface shows an example of a real time market demand element [127], namely the locations of one or more potential transactions [132]. In this example the locations of potential transactions are shown within the user defined first region [102]. In some embodiments, a real time market demand element is displayed within any portion of a user interface, including user defined map region, user rate summary, or date setting display area. Within the user interface shown here in FIG. 6, the base rate field is displayed on both the rate card and a background display comprising a first region [102]. The rate card displays region [103] which is a user-defined region fully contained within the first region. A user-defined region fully contained within a first region is alternately referred to as a second region, a third region, a fourth region, etc.. The example rate car shown in FIG. 6A also contains a default rate field [125], adjustment fields for user defined seasonal adjustment [115], quantity adjustment [114], and lead time adjustments [113].

FIG. 6B shows various aspects of an exemplary representation of an interface of a user of an online crop transaction system [312]. The interface of a user of an online crop transaction system is updated to display crop prices net transportation costs [135]. In some embodiments, the transportation costs used are the lowest cost custom rate of any transportation provider offering services within a geographic region where the crop product is located or where purchaser of a crop product would like the product delivered. The interface of a user of an online crop transaction system may be updated in real-time to reflect changes in the lowest custom rate within the transportation management system.

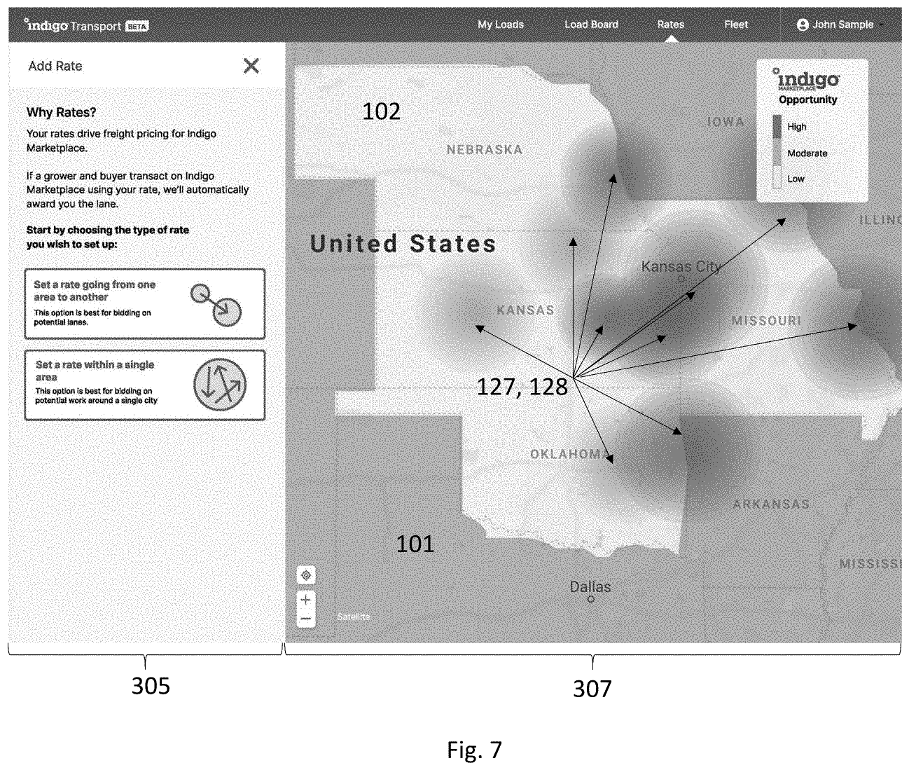

FIG. 7 shows an example of a transportation provider's user interface including a rate setting display area [305] and a map display area [307]. This example interface shows a map region [101], a user defined first region [102], as well as numerous real-time market demand elements [127]. In some embodiments, as shown here, the market demand design elements are a map layer colored proportional to market demand [128]. Unless specifically defined by context, market demand can refer to demand for or supply of transportation services or demand for or supply of goods to be transported (for example, commodity agricultural products such as corn and soybeans).

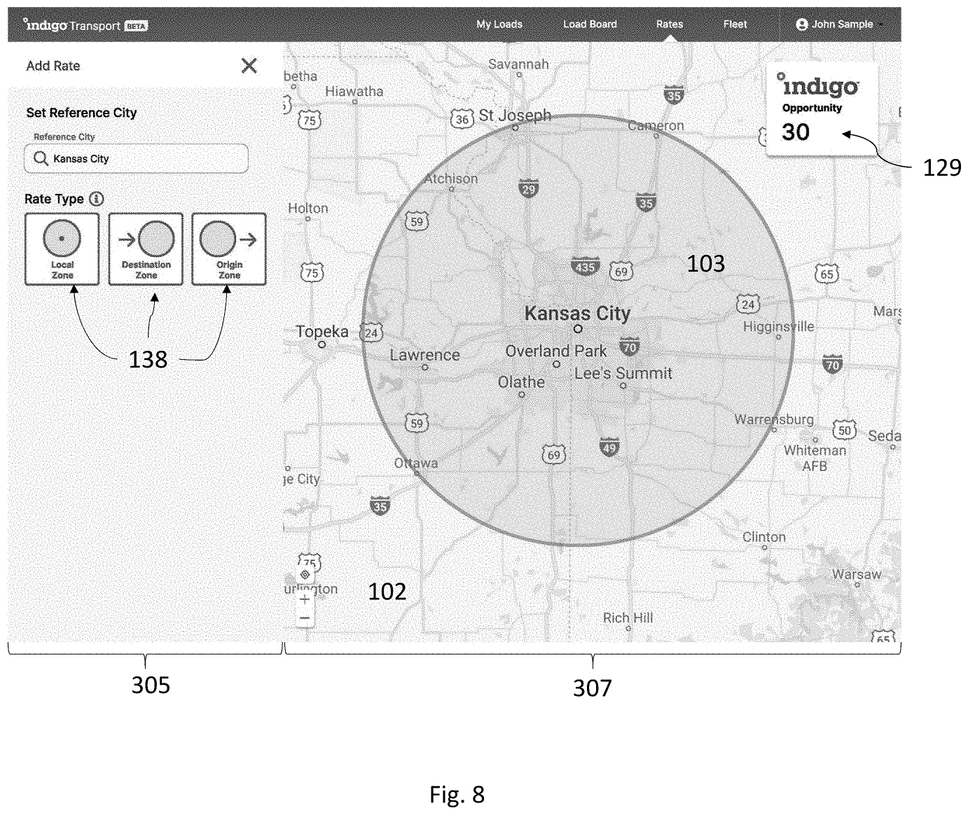

FIG. 8 shows another example of a transportation provider's user interface including a rate setting display area [305] and a map display area [307]. In this example the user has defined a first region [102] and a second region [103]. A second region describes a region having non-zero area with having an external boundary fully enclosed within a first region. The user has the choice of applying a zone type [138] to the second region. A local zone is a zone type describing a region within which transportation services would be provided, e.g. a local zone contains both an origin location and a destination location. Within a local zone an origin location and a destination location may be positioned anywhere within the zone. In some embodiments, the user interface includes a field for setting the minimum trip distance for a rate. Additional examples of zone types are destination zones and origin zones. This exemplary user interface also contains a real-time demand design element representing a number of transportation opportunities within the user-defined second region [129]. In some embodiments, the number of transportation opportunities within one or more user-defined regions represents the historical, current or projected number of transportation opportunities. Transportation opportunities is used synonymously with potential transactions, transportation bids, or transportation requests.

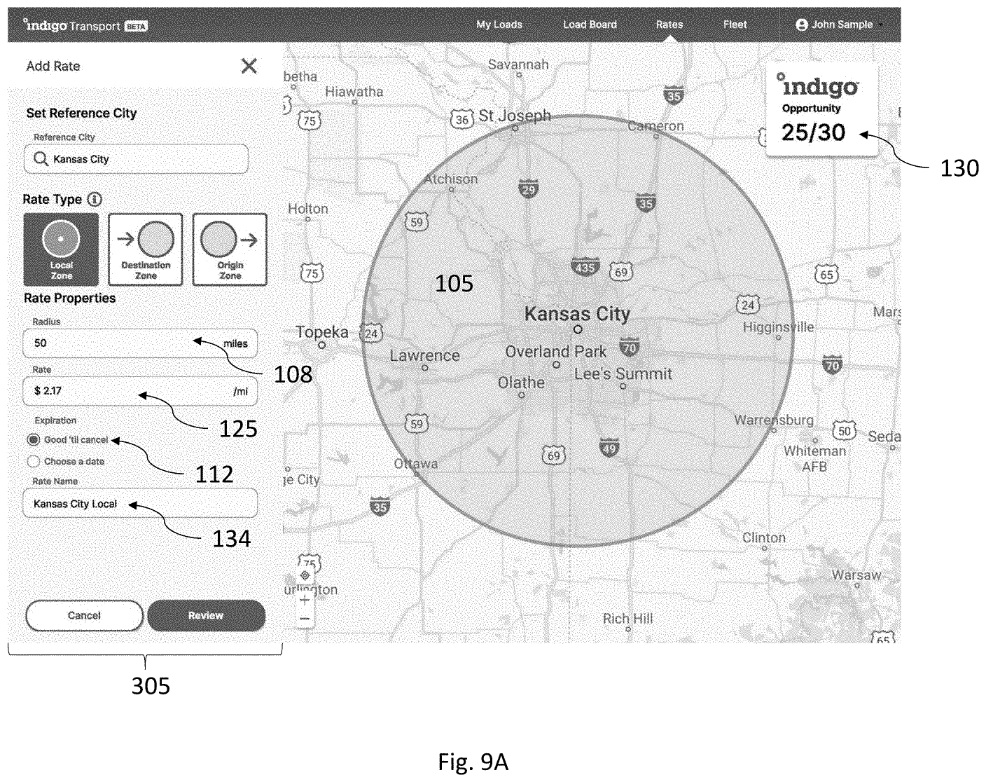

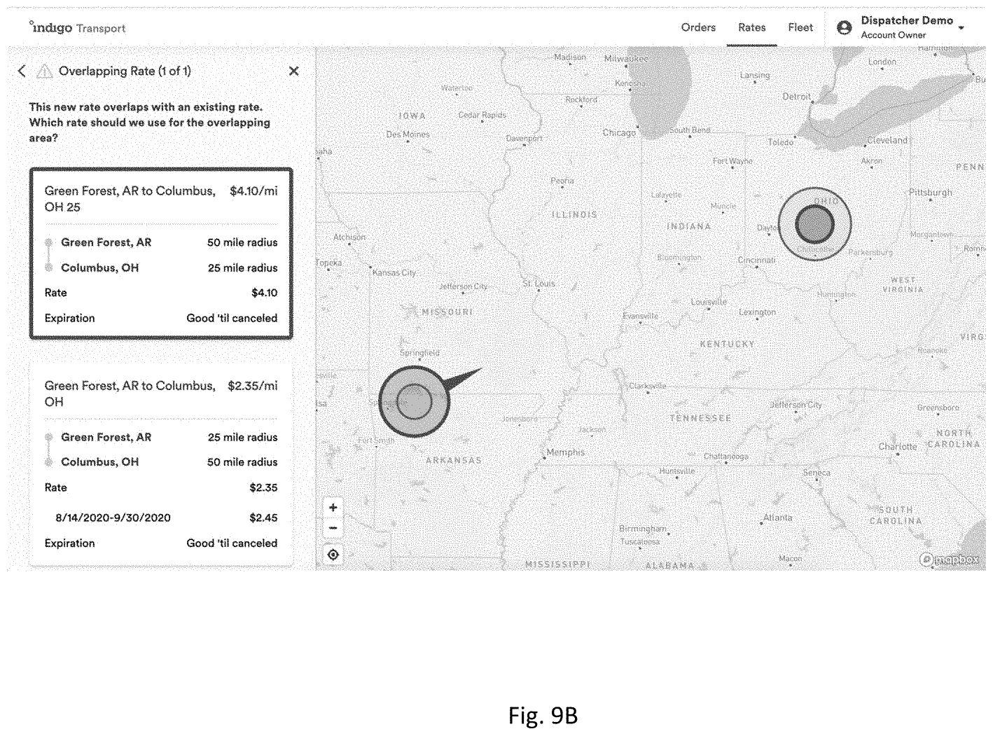

FIG. 9A shows another example of a transportation provider's user interface. This interface displays a user defined local zone [105], where the local zone represents a circular area having a radius of 50 miles set in a user determined radius field [108]. The default rate (synonymous with base rate) for providing transportation services within this local zone is set in the base rate field [125]. In some embodiments, the default rate for a user defined region is calculated automatically once the user creates the region. Such an automatically generated default rate may be displayed in on or more places within a user interface, including without limitation as shown in FIG. 9A in a rate setting display area [305] or as in the first panel of FIG. 1 within a map region [101]. An automatically generated default rate may be generated or continuously updated based on real-time market factors including open commodity bids. A rate setting display area [305], may, as is shown here, also contain an expiration parameter [112] for the user defined rate. In some embodiments, the expiration parameter may be a user provided date, period of time (e.g. 30, 60, 90 days), or an indication from the user to keep the rate open indefinitely (e.g. until canceled). A user may also provide a name for the rate [134]. In some embodiments, a default rate name is automatically generated. This example of a transportation provider's user interface also contains a real-time market demand design element. In this example a real-time market demand element is a proportion of opportunities within one or more user-defined regions meeting one or more rate parameters [130].

FIG. 9B shows another example of a transportation provider's user interface. In this example, conflict resolution is provided between multiple rate cards entered by a transportation provider. In particular, when an overlapping rate card is entered, the user is proactively asked to indicate which rate card should take precedence. In this way, upon rate card retrieval, no further prompt is required to automatically select the appropriate rate.

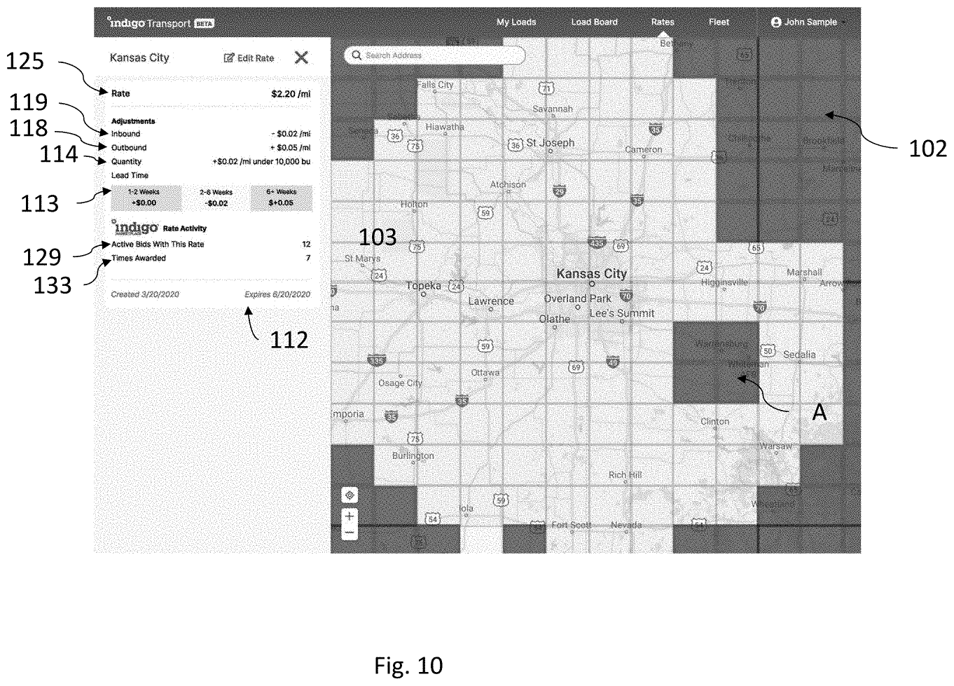

FIG. 10 shows another example of a transportation provider's user interface. In this example the user defined region [103] is fully contained within the user defined first region [012]. Here the user defined region [103] has an irregular shape, including an irregular boundary and an area within the outer bounds of the user defined region which is excluded from the user defined region (as shown by the arrow A). This exemplary user interface also includes a base rate field [125], an inbound adjustment [119], an outbound adjustment [118], a quantity adjustment [114], and three lead time adjustments [113], a number of active bids within the design region [129], a number of times the bid has been awarded [133], and an expiration date

. An inbound adjustment is synonymously referred to as a destination adjustment. The inbound adjustment [119], in this example is a $0.02 per mile reduction of the default rate for jobs (routes) having a destination within this region. An outbound adjustment is synonymously referred to as an origin adjustment. The outbound adjustment [118], in this example is a premium of $0.05 per mile over the default rate for jobs (routes) having a destination within this region.

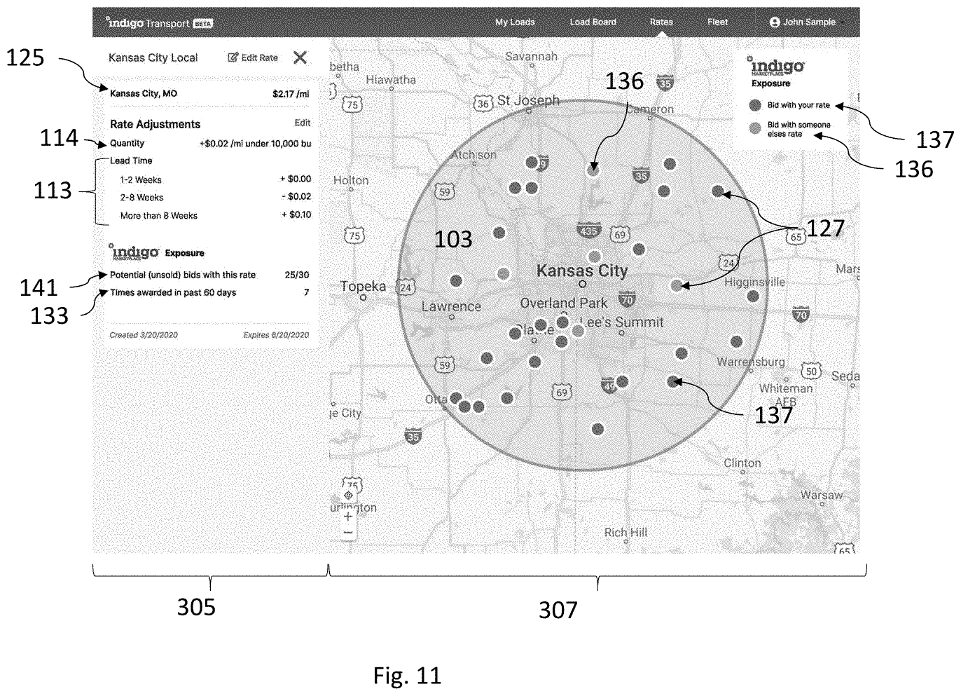

FIG. 11 shows another example of an interface of a user's device. In this example, a number of real-time market demand elements [127] are displayed within the user defined second region [103]. The market demand design elements [127] in this example include both locations of transportation opportunities matching user's rate within a region [137], and locations of transportation opportunities within a region matching the rate of a transportation provider other than the user [136]. This example shows that different real time demand design elements may be used in a rate setting display area [305] and a map display area [307] of a single user interface. The rate display area [305] includes a real-time market demand element indicating the proportion of eligible bids within the second region which are still available (unsold) [141], and a real-time market demand element indicating the number of times the current rate has been previously awarded [133]. In some embodiments, as shown here, the number of times a rate has been previously awarded [133] may be reported for a given period of time, e.g. 60 days. This example user interface contains a base rate field [125], a quantity adjustment [114], lead time adjustments [113]. Three market lead time adjustments [113] are displayed. The first shows that loads with transportation dates between 1-2 weeks in the future are associated with no change to the default rate. The second lead time adjustment applies to loads with transportation dates between 2-8 weeks in the future, loads within this time range will received a $0.02 per mile discount relative to the default rate. The third lead time adjustment applies to loads with transportation dates more than 8 weeks in the future, loads within this time range will increase the per mile default rate by $0.10 per mile.

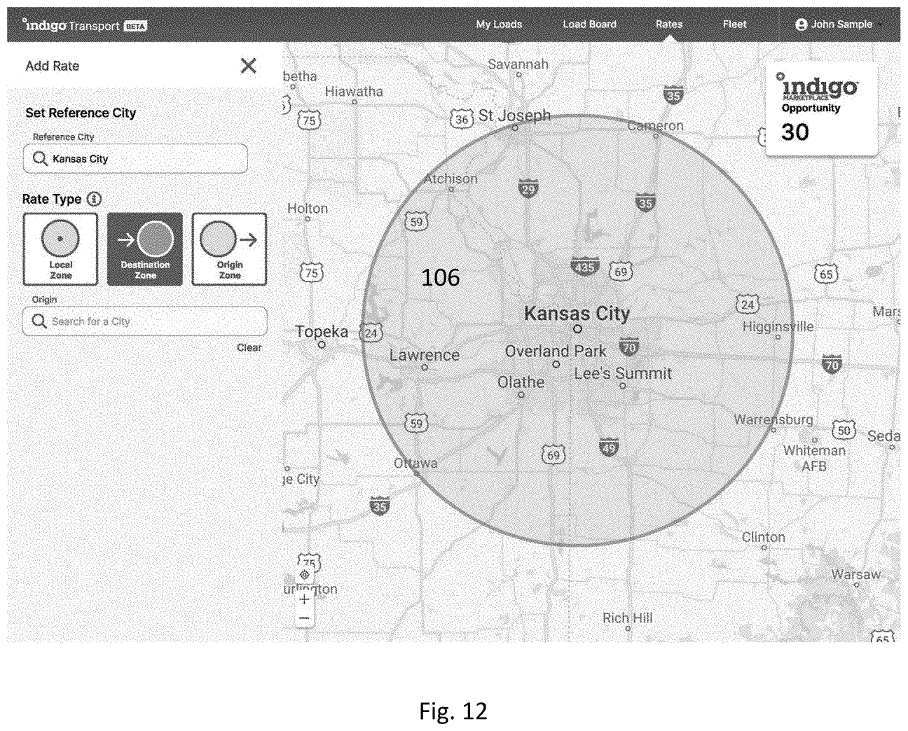

FIG. 12 shows another example of an interface of a user's device. In this example, the user has drawn a destination zone [106].

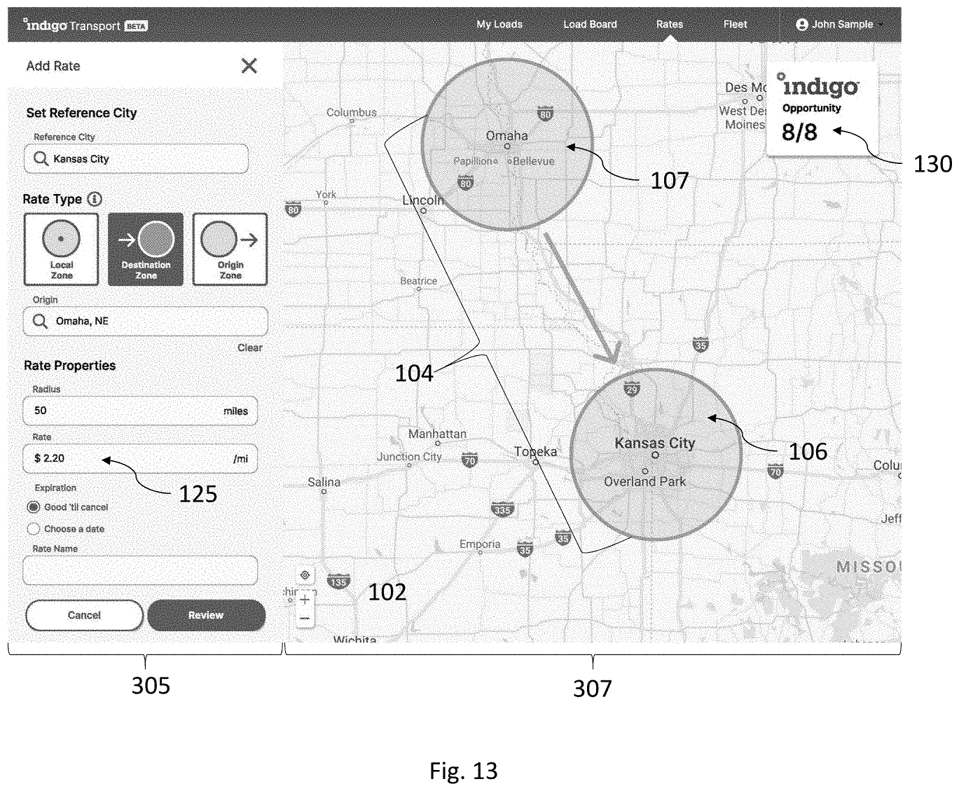

FIG. 13 shows another example of an interface in which a user may set parameters of actionable jobs based on current demand information displayed within a rate setting display area

and a map display area [307] of a single user interface. In this example a real-time market demand element shows the proportion of opportunities within the user-defined regions [106] and [107] meeting one or more rate parameters [130]. In this example where the default rate field [125] says $2.20 per mile, all 8 of the opportunities within the user defined regions [106] and [107] meet one or more rate parameters. In this example the map display area [307] shows a first region [102], and a lane [104] created by the combination of an origin zone [107] and a destination zone [106].

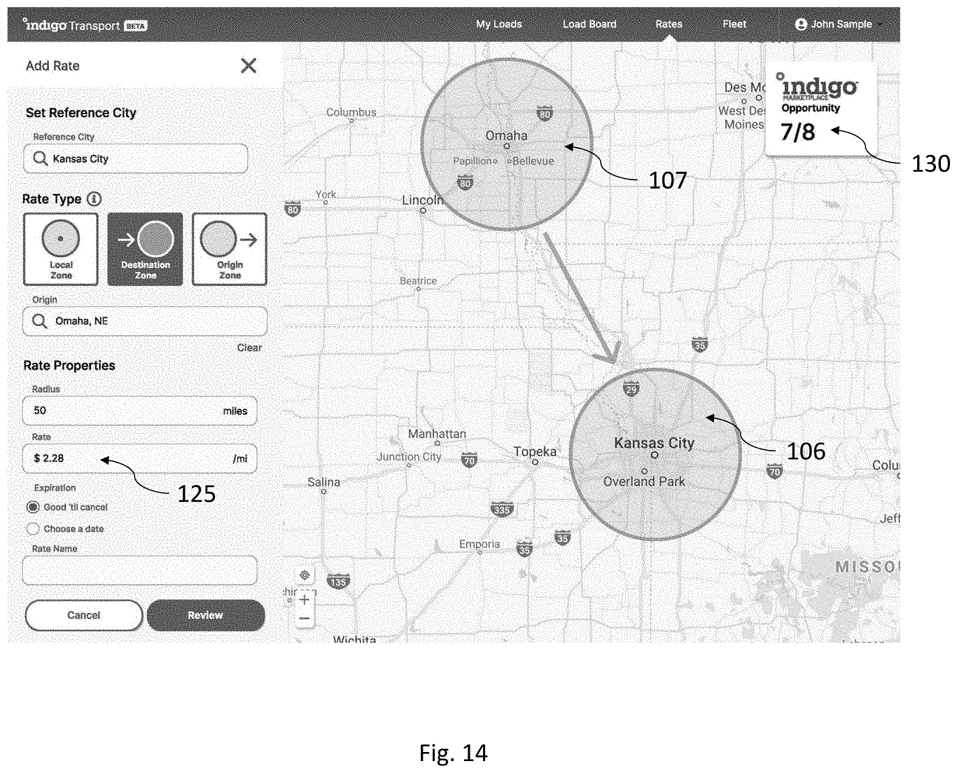

FIG. 14 shows another example of an interface. Like in FIG. 13, this example also shows a real-time market demand element of the proportion of opportunities within the user-defined regions [106] and [107] meeting one or more rate parameters [130]. In this example where the default rate field [125] says $2.28 per mile, only 7 of the 8 of the opportunities within the user defined regions [106] and [107] meet one or more rate parameters.

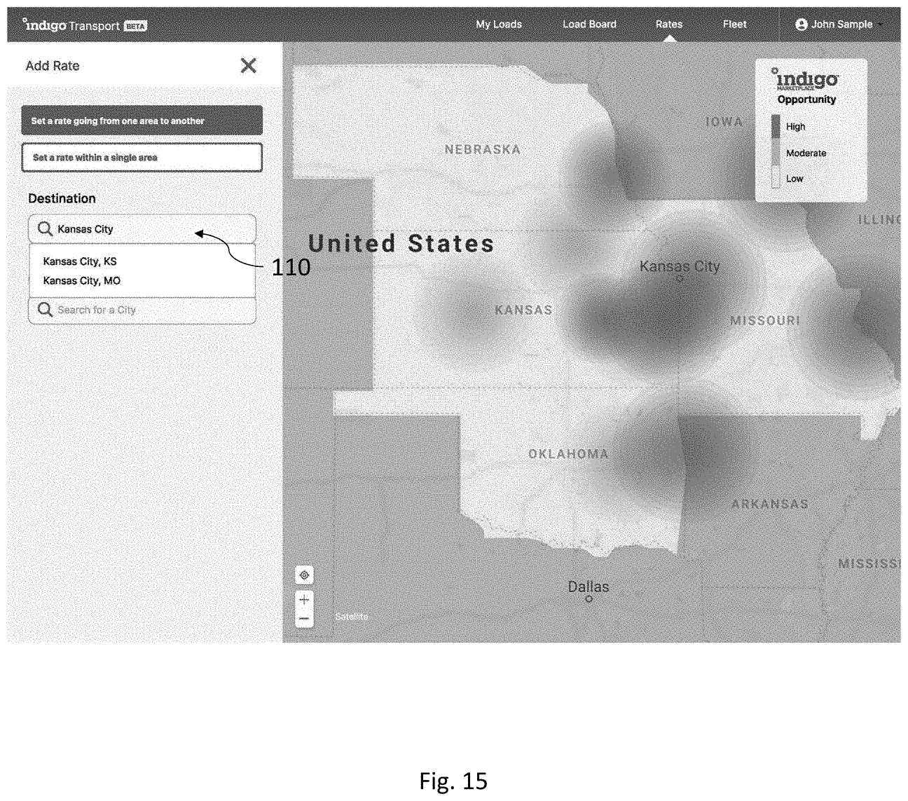

FIG. 15 shows an example of a user interface where a user may search for a destination and origin location. A destination location [110] and origin location may be a political designation such as a city, state, province or geolocation such as GPS coordinates. In some embodiments, a destination location or origin location may be determined by user or populated automatically (for example, in response to display of the particular map region, or based on a high demand region, or a region having the highest predicted profitability based on a user's transaction history).

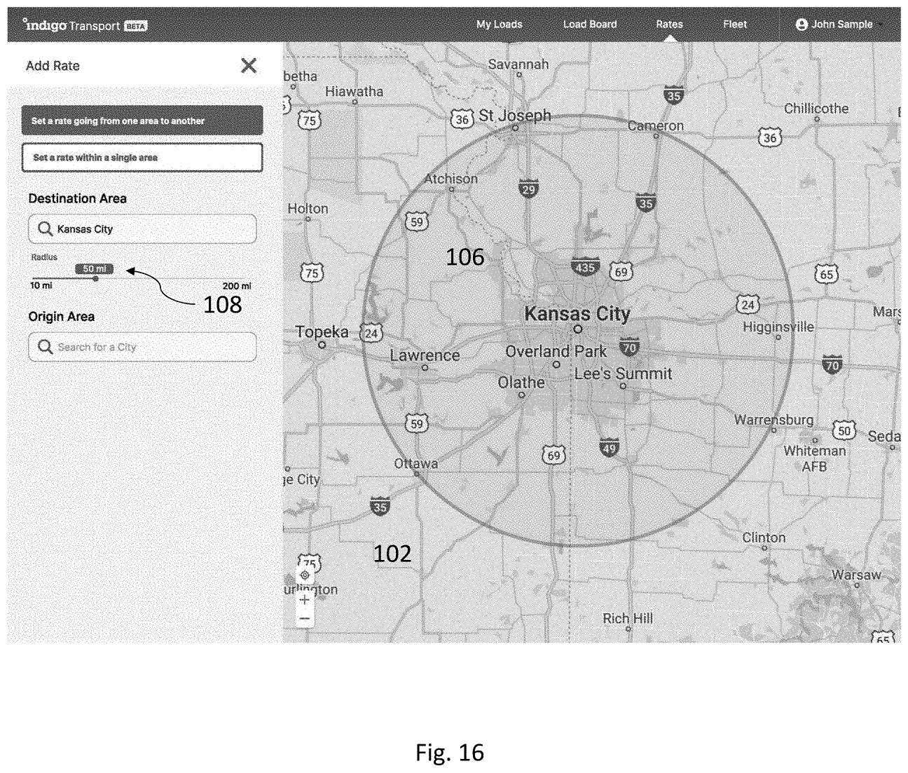

FIG. 16 shows an example of a user interface containing a portion of a user defined first region [102], and a user defined destination zone (alternately referred to as a destination area) [106 ]. In this example the user defined the destination zone by searching for a geographic location (Kansas City) and defining via the user defined field, here a slide indicator, a radius of 50 miles [108]. In some embodiments, as region may be defined by all or part of an administratively determined boundary for example a state line. In other examples, a region may be defined by an outer perimeter of an area defined by one or more administratively determined boundaries for example the of adjacent states as shown in panel one of FIG. 2.

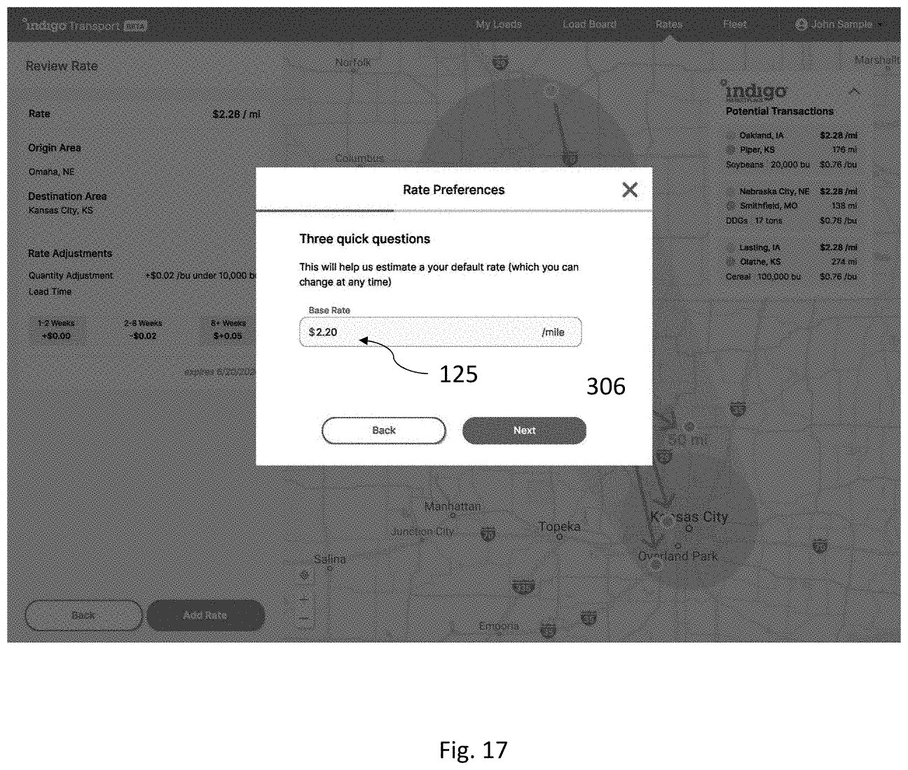

FIG. 17 shows an example of a rate setting dialog box [306] containing a base rate field [125].

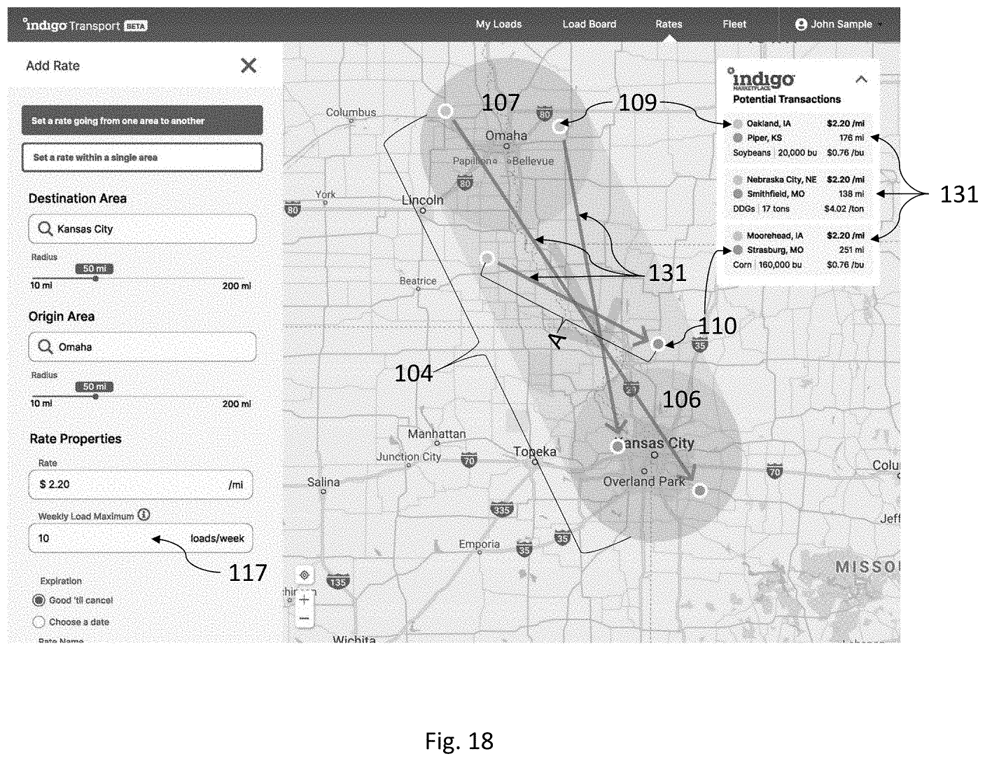

FIG. 18 shows within an exemplary user interface, real-time market demand elements that are details of one or more potential transactions within one or more user-defined regions [131]. Detail of one or more potential transactions within one or more user-defined regions [131] are represented in this example as both text summaries and as lines on a map connecting the origin locations [109] and destination locations [110] of the potential transactions. Detail of one or more potential transactions may include a metric of the potential transaction relevant to a transportation decision, including without limitation: the origin location, the destination location, the rate associated with fulfilling the potential transaction, a type of good to be transported (if any), and a volume of good to be transported. This example interface includes a lane [104] created by the combination of an origin zone [107] and a destination zone [106]. In some embodiments, a trip is displayed within a user defined lane [104] even though the trip's origin location is not within origin zone [107] and or the trip's destination location is not within the destination zone [106], such a lane is shown in this figure as A. In some embodiments, one example is shown here, an interface is modified to display available loads that are similar but not identical to parameters defining a transportation provider's rate. An additional, optional, parameter shown in this example user interface is a maximum number of loads parameter [117]. This defines the maximum number of loads a transportation provider is willing to accept within a given period of time (where the given period could be 0 or infinite). In some embodiments, the maximum number of loads parameter is associated with a time range, such as the maximum number of loads per week, month, quarter, year, etc. In some embodiments, a user interface includes a minimum number of loads parameter, indicating the minimum number of loads that must be available to the transportation provider.

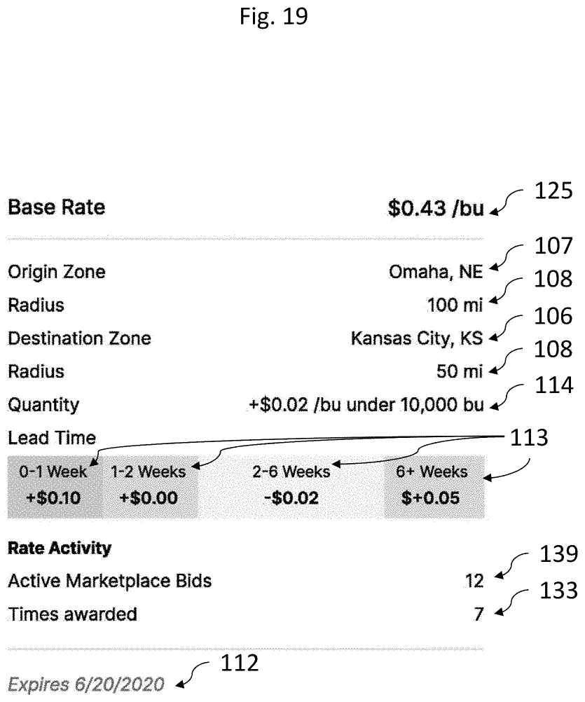

FIG. 19 illustrates an additional example of a portion of a user interface. A similar representation as shown in FIG. 19, is in some embodiments, presented within a rate setting dialog box or within a map display area. This example user interface includes a default rate field [125], an origin zone having an administratively defined boundary such as a city [107], a radius [108 ] describing an additional area beyond the boundary of the origin zone or destination zone, a destination zone having an administratively defined boundary such as a city [106], a quantity adjustment [114], one or more lead time adjustments [113], real-time market demand elements showing the number of active commodity market bids [139] and the number of times a user's rate has been awarded [133], and an expiration parameter [112]. In some embodiments an expiration parameter is set by a user, in some embodiments the expiration parameter is set automatically by the transportation management system.

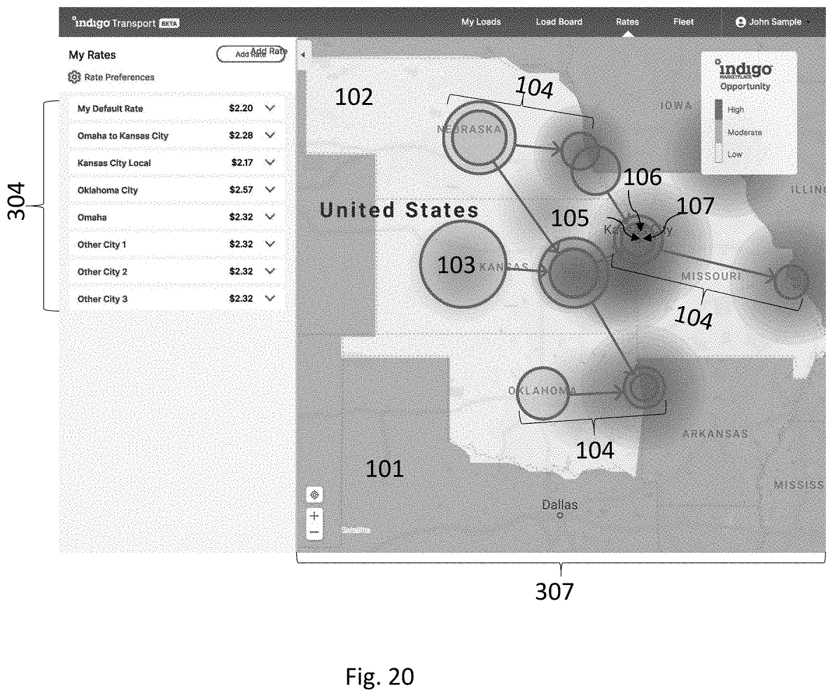

FIG. 20 describes another example of a user interface of a transportation provider. In this example, a user rate summary [304] is shown with a map display area [307]. In this example the map display area, includes a map region [101], almost an entire user defined first region [102], user defined regions [103, 105, 106] located entirely within the first region, and multiple user defined lanes [104]. A single user defined zone (synonymously a user defined region) may be a part of multiple lanes and a single user zone may be simultaneously a local zone [105], a destination zone [106] and an origin zone [107].

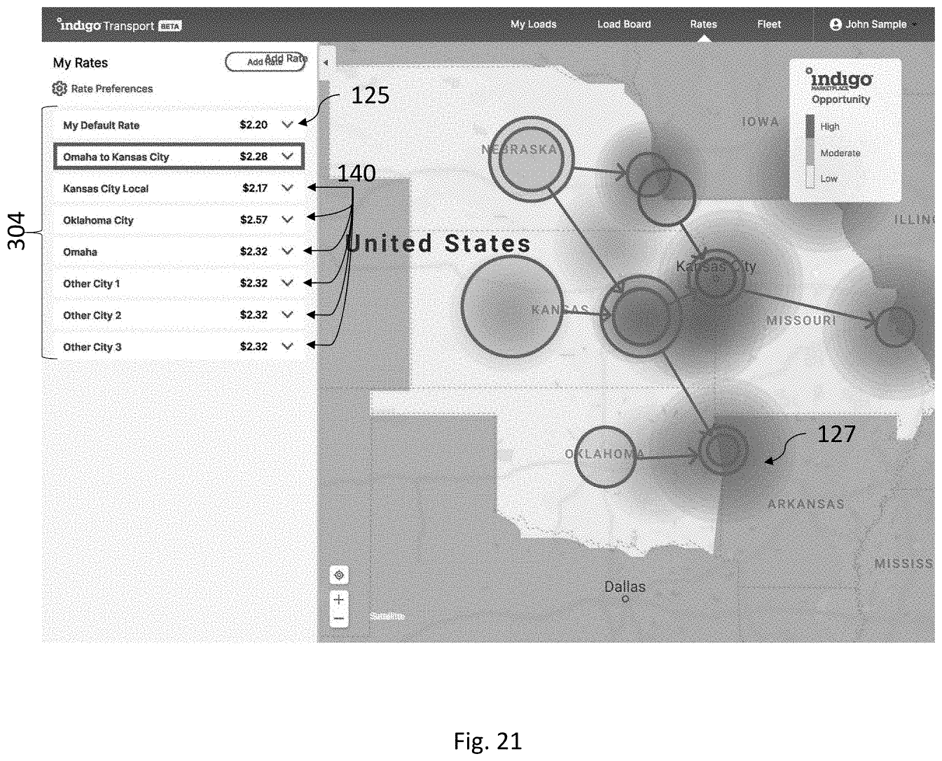

FIG. 21 shows another example of a user interface comprising a user rate summary [304]. A user rate summary [304] may contain any combination of default rates and custom rates [140]. A user rate summary [304] may include a user editable global default rate field [125]. In this example, changes to a global default rate field [125] will automatically update all custom rates [140 ] associated with that default rate, and display those changes within the user rate summary [304]. A user interface may include real-time market demand elements [127] within the same user interface as a user rate summary [304].

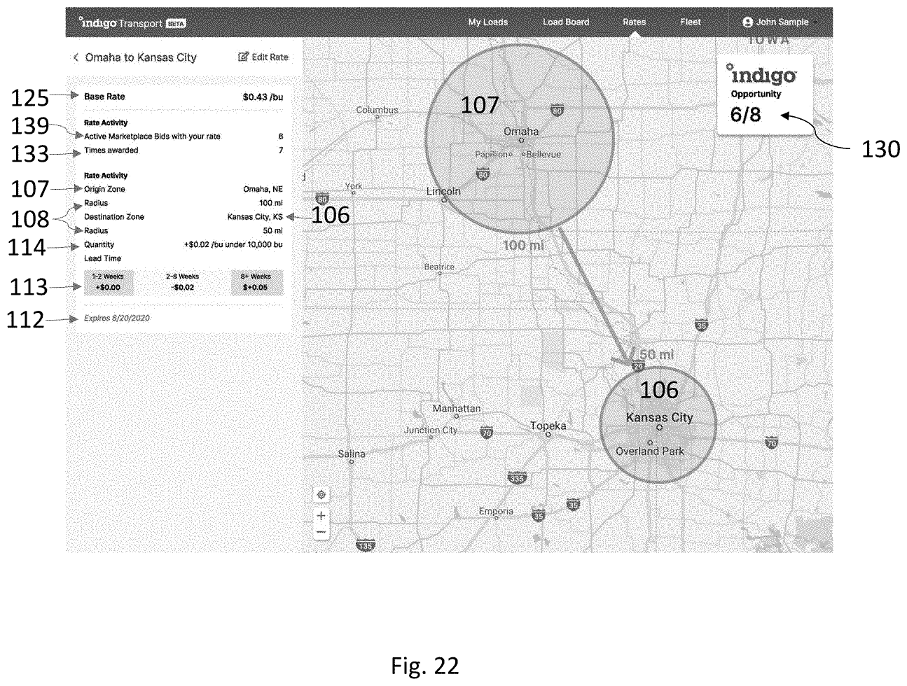

FIG. 22 describes another example of a user interface of client device of a transportation provider. This example user interface includes a default rate field [125], an origin zone having an administratively defined boundary such as a city [107], a radius [108], a destination zone having an administratively defined boundary such as a city [106], a quantity adjustment [114], one or more lead time adjustments [113], real-time market demand elements showing the number of active commodity market bids [139] and the number of times a user's rate has been awarded [133] and the portion of opportunities within the user defined lane comprising origin zone [107] and destination zone [106] which meet all rate parameters [130], and an expiration parameter [112].

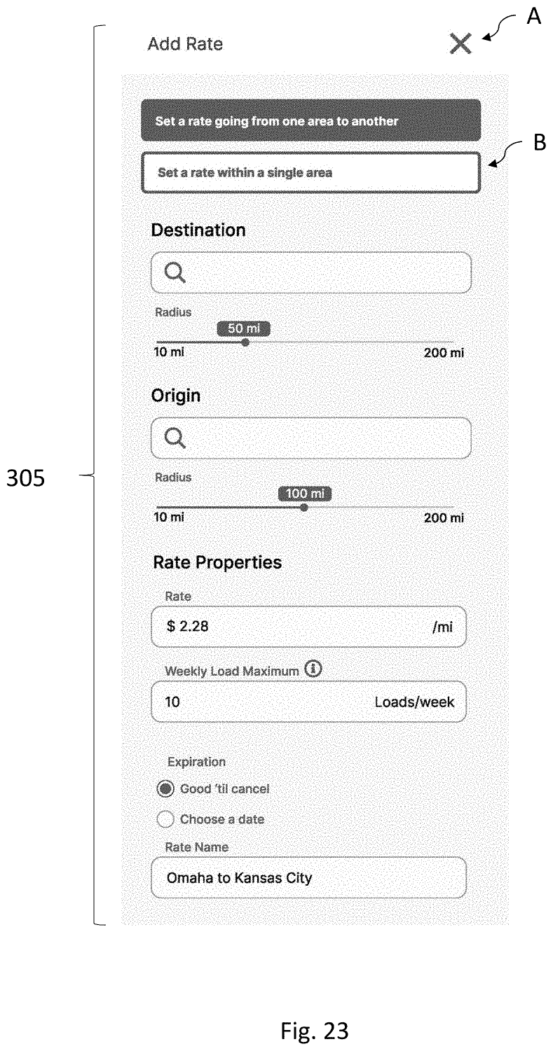

FIG. 23 illustrates an exemplary rate setting display area [305]. A rate setting display area is, in some embodiments, presented within a rate setting dialog box or within a map display area. In some embodiments, a rate setting display area includes a design element such as the X marked as A, which a user may click, tap or otherwise select to close or minimize the rate setting display area. In some embodiments, a rate setting display area contains one or more selectable regions which a user may click, tap or otherwise select in order to generate a set of user input fields. In this example, selecting the button marked as B would change the user editable fields so that a user would set an origin location and destination location within a single region.

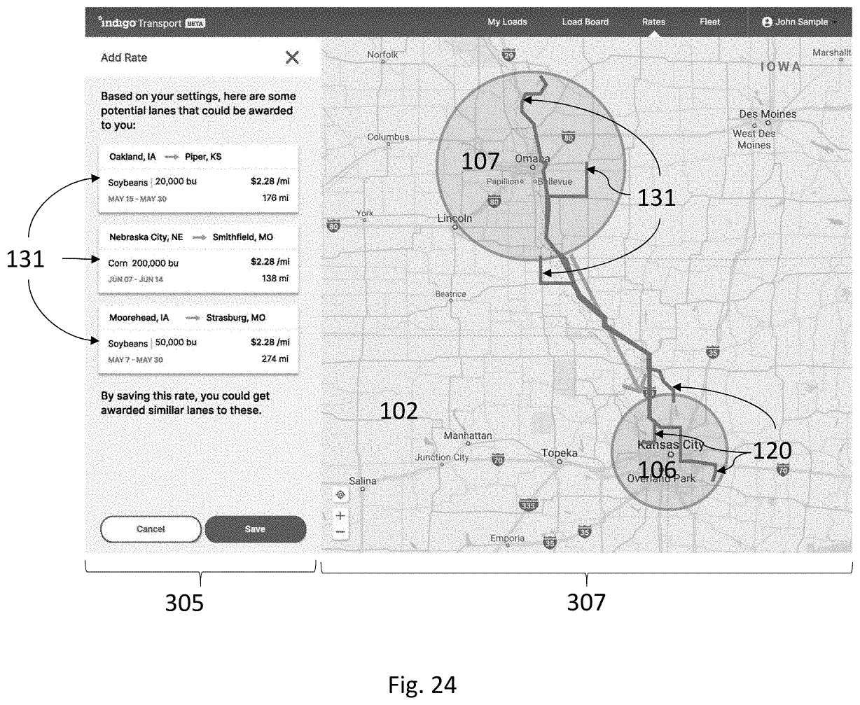

FIG. 24 describes an example of a rate setting display area [305] and a map display area [307] displayed within a user interface of a transportation provider. In this example real-time market demand elements are details of one or more potential transactions within one or more user-defined regions [131] which are represented in both the rate setting display area [305] and the map display area [307]. The details of one or more potential transactions within one or more user-defined regions [131] may be displayed on a map as routes [120]. In this example, the map display region includes a portion of a user defined first region [102], and the origin and destination location of each route is within a user defined region [107, 106] fully enclosed within the first region. In other embodiments, both the origin and destination location of each route are within a user defined first region and at least one of the origin location or destination location of each route is within a user defined region fully enclosed within the first region [103].

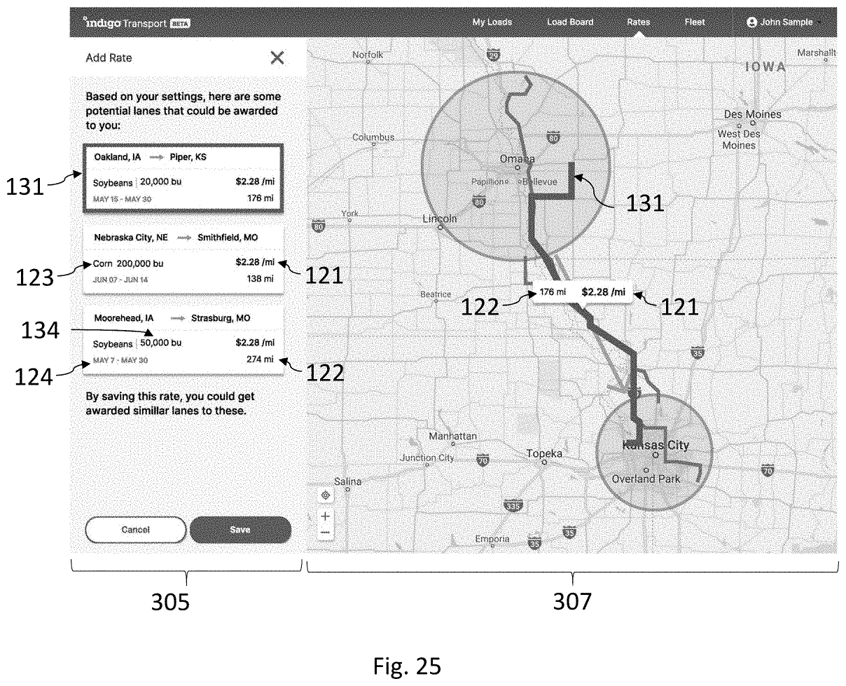

FIG. 25 shows an example of a user interface wherein market demand elements are details of one or more potential transactions within one or more user-defined regions [131] represented in both the rate setting display area [305] and the map display area [307]. In this example, details of the one or more potential transactions includes the type of good to be transported [123], the rate associated with fulfilling the potential transaction [121], a volume of good to be transported [134], a period of time during which the transportation services are to be provided (alternately referred to as a delivery window) [124], and the total mileage of the route [122], and the route. In some embodiments, a user may select (for example, by clicking or tapping) a representation of a potential transaction within one or more user-defined regions (for example, representations as indicated by [131] in FIG. 25) and thereby automatically execute an agreement to provide transportation services. In other embodiments, a transportation provider does not need to make an action such as a tap or click to automatically execute an agreement to provide transportation services, for example, if a transportation provider's rate (custom or default) matches the requirements of a transportation opportunity and the transportation provider's rate is the lowest of any provider offering to provide services within the relevant geography a transaction may be initiated by a transportation management system without user interaction.

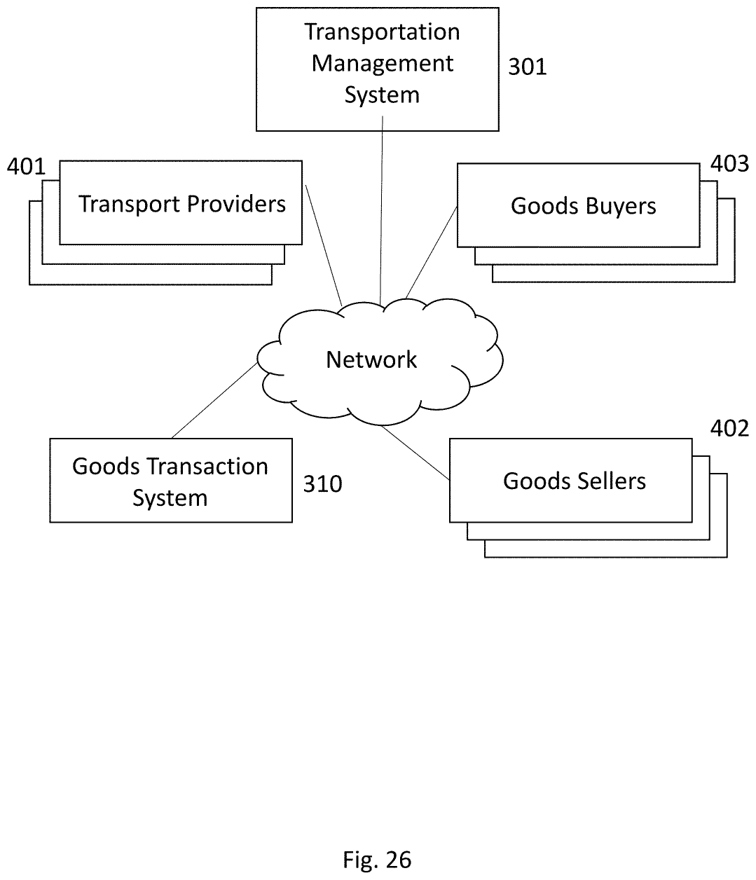

FIG. 26 is a block diagram of a system environment for a goods transaction system 310 and a transportation management system 301. The system environment comprises one or more good sellers (for example growers of commodity crops or agricultural goods) 402, one or more buyers of goods [403], and one or more transportation providers [401]. In an embodiment, the goods transaction system [310] and the transportation management system [301] include an integrated web or mobile application and a back-end computing infrastructure (such as one or more web servers). In another embodiment, the goods transaction system [310] includes a first web or mobile application and the transportation management system [301] includes a second web or mobile application distinct from the first web or mobile application. In alternative configurations, different and/or additional components may be included in the system environment. For example, the system environment may include additional or fewer growers, buyers, external data sources, and/or transportation entities. Likewise, in some embodiments, the goods transaction system [310] and the transportation management system [301] are unrelated and/or are managed by different entities. In various embodiments, the system environment include more than one goods transaction system [310]. In some embodiments, a goods transaction system is a crop transaction system.

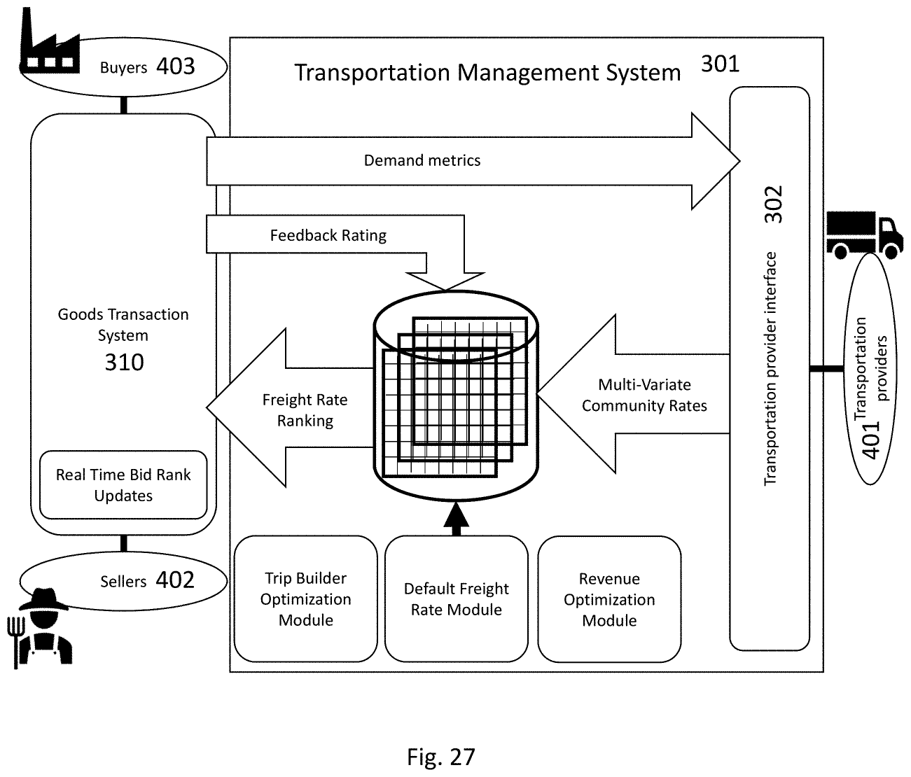

FIG. 27 shows an example of participants' interactions between a goods transaction system [310], a transportation management system [301], buyers [403], sellers [402] and transportation providers [401].

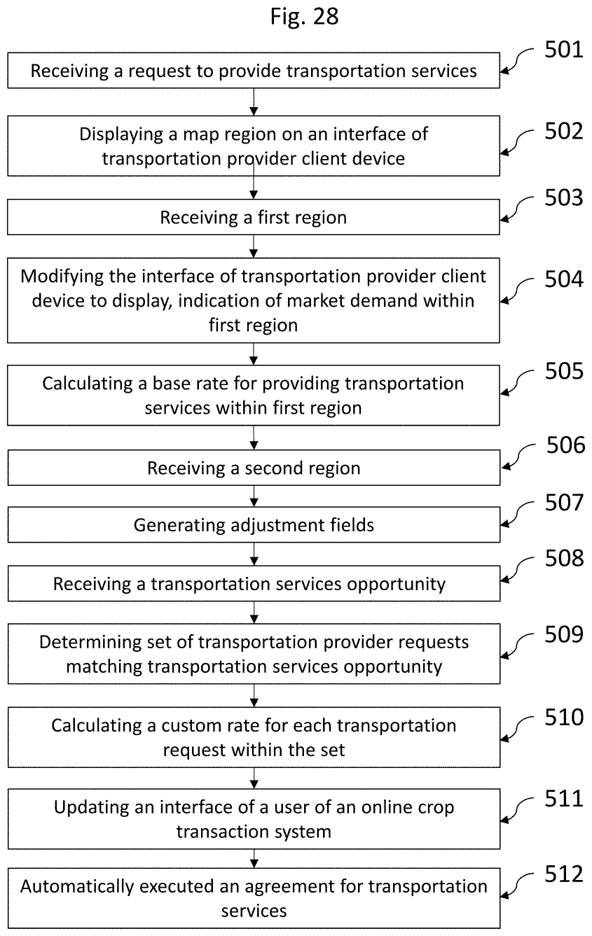

FIG. 28 illustrates a method for automated real-time rate card management comprising steps of: receiving from each of a plurality of transportation providers a request to provide transportation services [501], displaying a map region on an interface of a client device of each transportation provider [502], receiving from each transportation provider via their client device a first region having non-zero area within the map region [503], modifying the interface of each client device to display, in real-time, an indication of market demand within each transportation provider's first region [504], calculating a base rate for providing transportation services within each transportation providers' first region and modifying the interface of each transportation provider to display the base rate in a field editable by each transportation provider [505], receiving from each transportation provider via their client device a second region having non-zero area contained within their first region [506], in response to receiving the second regions, generating within each interface of a client device of each transportation provider one or more user editable fields including: an expiration field, and one or more adjustment fields, where at least one of the one or more adjustment fields are selected from the list consisting of a seasonal adjustment, an origin adjustment, a destination adjustment, a lead-time adjustment, and a quantity adjustment [507], receiving a transportation services opportunity comprising an origin location, a destination location, a price of a good to be transported, and a delivery window [508], determining the set of the transportation providers' requests wherein the origin location or destination location of the transportation services opportunity are within the transportation providers' second regions and the transportation providers' expiration date are not before the beginning of the delivery window [509], for each transportation providers' request within the set, calculating a custom rate to provide transportation services for the transportation services opportunity based on each transportation providers requests' base rate and adjustments [510], updating in real-time an interface of a user of an online crop transaction system with the price of a good to be transported less the cost to transport that good at the lowest calculated custom rate of the transportation providers' request within the set [511], in response to a transaction to purchase the good to be transported, automatically executed an agreement for transportation services with the transportation provider having the lowest calculated custom rate [512]. The method described in FIG. 28 may use any of the user interfaces described herein.

It will be appreciated that a key value of systems set forth herein are their ability to link supply (growers) and demand (buyers). In particular, for a given grower, this corresponds to being able to show their best bid net of transport. To elaborate a list of best bids, for every relevant bid, its basis net of transport may be generated and then the bids may be sorted by net basis to select the top ones. However, this naive approach is not appropriate in scenarios where some of the following conditions are met: the best bids must be calculated on demand; calculating freight costs is too costly or time-consuming; there is a large number of bids or growers.

The below describes an algorithm that uses a decorated ball trees for performing an efficient retrieval of the best bid net-of-transport for a grower. This data structure is constructed using haversine distances, although other distance metrics that satisfy the triangle inequality can be used. Similar variations of the algorithm can be implemented for related queries (e.g., best growers for a buyer, best bids within a given radius, etc.). Other related spatial data structures, such as k-D trees, can also be used in a similar way.

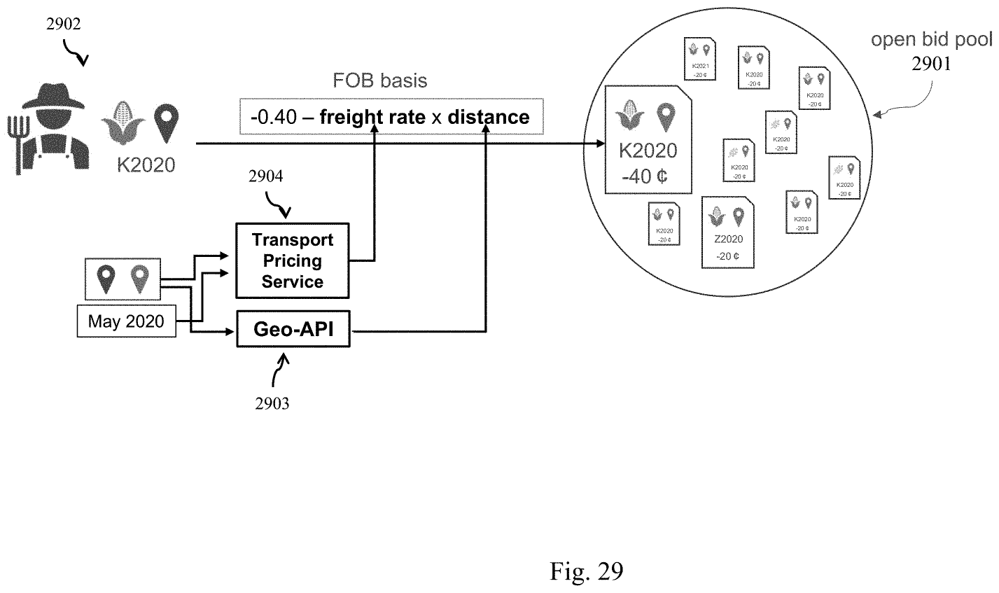

Finding the top FOB (Free On Board, i.e., ownership changes at the time that a shipment is picked-up at the farm) bids among all open bids requires matching a grower's crop and delivery and calculating freight costs. Referring to FIG. 29, an exemplary system is illustrated. An open bid pool 2901 includes a plurality of bids, each including a location and price. To determine a FOB basis, the location of the grower 2902 and the location of a given bid must be determined. Geo-API 2903 is used to determine the actual road distance between the buyer and the bid. Transport Pricing Service 2904 is used to determine the freight rate for the given locations and date. In various embodiments, Transport Pricing Service 2904 uses rate cards as set forth above. In various embodiments, Transport Pricing Service 2904 uses one or more predictive model to determine freight costs. The FOB basis may then be computed as bid price—freight rate x distance.

However, determining an efficient bid ranking of a large bid pool requires a potentially prohibitive amount of computation if an exhaustive search is performed. For example, a full-search approach would entail finding all bids that match the supply, determining a distance (e.g., via Geo-API 2903) and determining freight pricing (e.g., via Transport Pricing Service 2904), computing the basis net of transport, and then ranking the bids. For every bid with matching metadata (same crop, futures month, and year) the grower's net-of-transport basis is computed. It will be appreciated that such a full search approach does not scale well. In particular, sorting all B bids and then selecting the top N gives complexity of O(B logB). Thus, for an exemplary 1,000 grower locations and 10,000 bids, over 132 million steps would be required to determine the rankings. This complexity may be reduced by using a size-limited, double-ended queue to hold the top N bids. In this case, the algorithm would have a best-case complexity of O(N log N+B) and a worst-case complexity O(B log N+B) for each grower location.

One approach to reducing the computational load would be to limit the bids searched using a relatively cheap computation prior to performing further computation. Exemplary search limiting steps include: including only bids within a fixed haversine distance of the grower; including only the N most proximate bids, or including only bids with an approximate FOB meeting a minimum value.

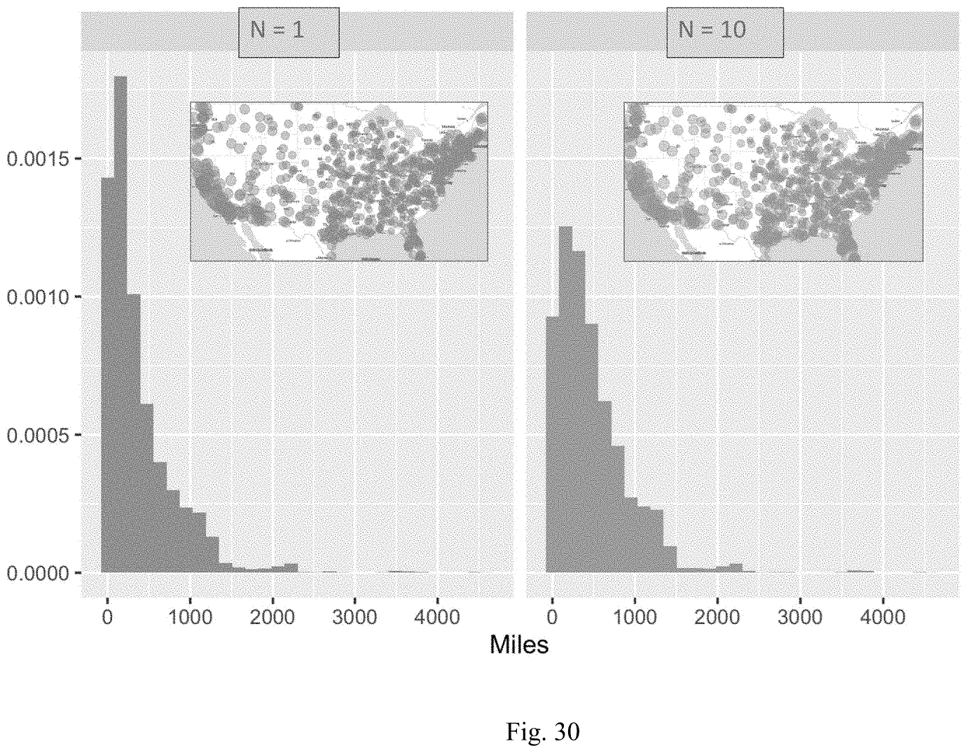

However, these approaches provide only a statistical guarantee of correctness. In practice, obtaining a high confidence requires looking at bids that are a great distance away. This is illustrated in FIG. 30, which plots the distance to the Nth best bid for a random sample of ZIP codes.

To address this shortcoming of alternative approaches, the present disclosure provides an efficient and correct bid ranking algorithm. The algorithm includes two major components: a custom spatial index that stores the bids in memory using a decorated ball tree; and heuristics for index exploration that prune the search for the best bids.

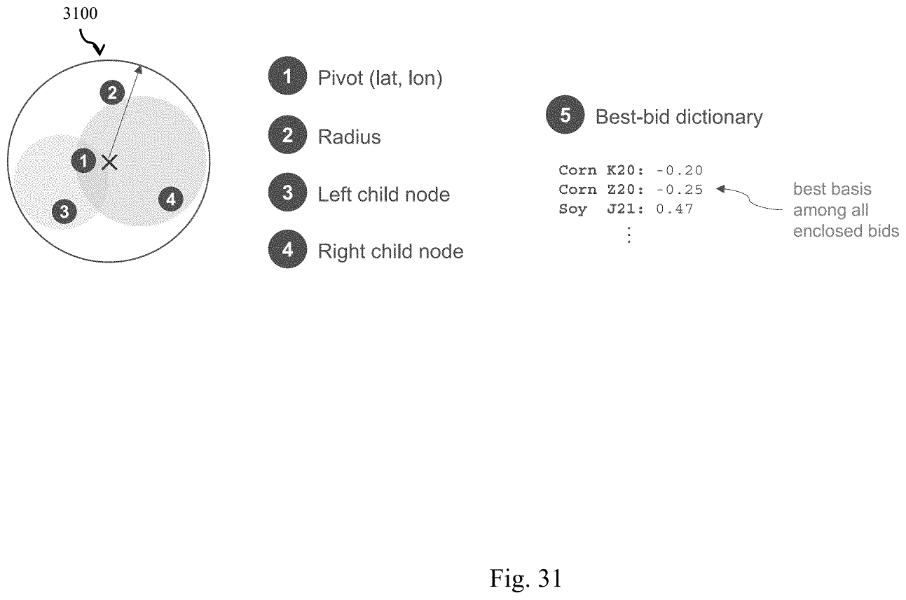

Referring to FIG. 31, a decorated ball tree is illustrated according to the present disclosure. The decorated ball tree is a hierarchical spatial index in the form of a binary tree, used to store the bids. Each non-leaf node 3100 includes a pivot, a radius, and a best bid. In various embodiments, a best bid is included for each relevant category (e.g., crop and delivery) among all bids enclosed in child nodes. Each non-leaf node includes a left child node and a right child node. Leaf nodes include a best bid list instead of a left and right child node.

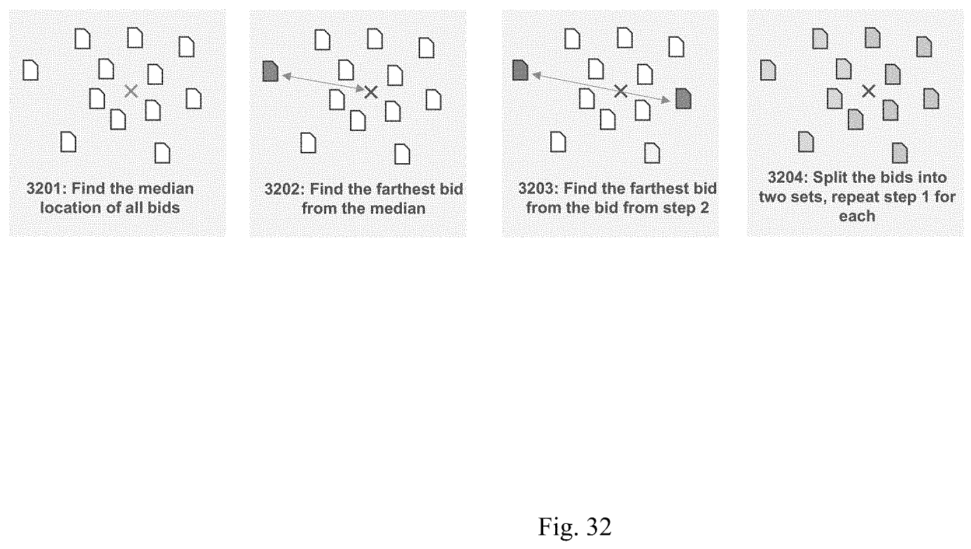

In various embodiments, a recursive bulk insertion algorithm is used to construct the tree as illustrated in FIG. 32. The objective is to construct balls that are small and have as little overlap as possible. At 3201, the median location (centroid) of a set of bids is located. The current node's pivot is set to the centroid. At 3202, the furthest bid (p₁) from the centroid is located. The node's radius is set to that maximum distance. At 3203, the furthest bid (p₂) from the bid located in the prior step (p₁) is located. At 3204, the set of bids is split into two subsets based on proximity to the two previously identified bids (p₁, p₂). Each of the two subsets is assigned to a child node, and the process is then repeated for each subset. If the set of bids decreases below a minimum size, then the node is a leaf node, which is populated with that set of bids. Node splitting stops when the number of bids is less than a predetermined size limit. It will be appreciated that online insertion and deletion of bids may be provided in addition to pre-construction of the tree.

The construction will generate a tree with log N+1 levels (ignoring truncation driven by the node size limit), and on each level there are 4 N distance calculations. Thus, the distance calculation function will be called O(4 N log N+4 N) times when constructing the tree. Increasing the node size will reduce the depth of the tree and the construction effort, but it will also increase the effort on querying the tree.

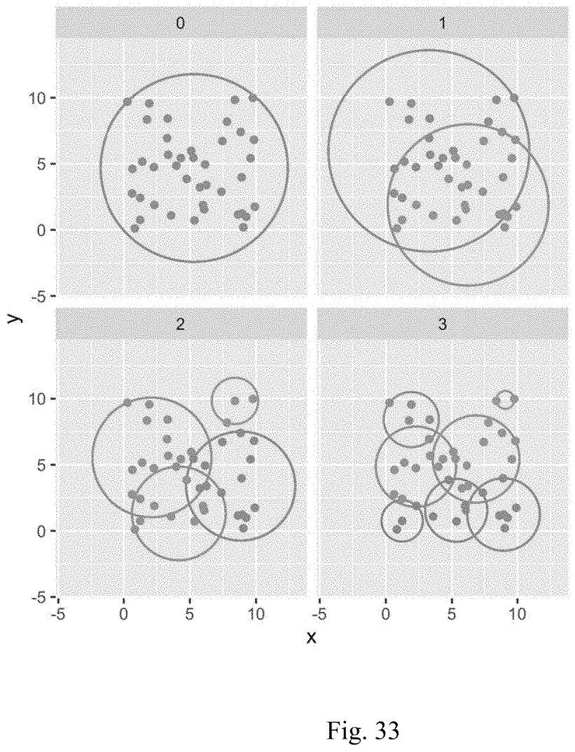

FIG. 33 illustrates the first 4 levels of a ball tree in Euclidean space, with 40 random points. The balls generated at each level and the points belonging to each ball are shown. Balls can overlap, but a point is associated with exactly one ball at each level.

In order to perform efficient search of the ball tree, heuristic search may be employed. The search problem may be phrased as follows: given a grower supply point g (with crop and delivery), find the top N bids by basis net of transport (FOB bids). A ball tree containing all open bids is searched. In addition, distance and freight heuristics (dist^{H} and rate^{H}, respectively) are combined to provide a FOB heuristic (FOB^{H}) that overestimates net basis.

dist^{H}(g, b)≤dist(g, b)

rate^{H}(g, b)≤rate(g, b)

FOB^{H}(basis, g, b)=basis−dist^{H}(g, b)·rate^{H}(g, b)≥basis−dist(g, h)·rate(g, b)=FOB(basis, g, b)

During search, a priority queue of size Nis maintained, holding the bids located to date, sorted by actual FOB.

At each non-leaf node, a decision is made as to whether to traverse its children. If the queue has fewer than N items, the children are always traversed. A node cannot contain a better bid if:

node.best_basis−(dist^{H}(g,c)−r)·rate(g,c)≤FOB_{N}

Accordingly, the child nodes are traversed only where there is the possibility of a better bid. g corresponds to the grower supply point, c corresponds to the center of the ball, and r corresponds to the radius of the ball.

At each leaf node, all bids are evaluated and the queue is updated using exact FOB, computed from actual distance and price data rather than a heuristic. If the FOB of a bid in the leaf node's list is favorable to the a bid in the queue (or the queue has less than N bids), the bid is inserted to the queue. Bids can be evaluated in a batch.

In exemplary embodiments, given a test point q and one or more desired BidCategory, a current_node variable is set to point to the root of the ball tree and a size-limited, double-ended priority queue top_n is initialized to hold the best bids (sorted by net basis). The search process may then be summarized as follows:
1. If current node is a leaf node, then loop over current node.bids, compute their net basis, and insert into top_n any bid whose category matches the target set of categories (note that actual insertion will only occur if the current size of top_n is less than N or if the bid's net basis is greater than the top_n.last, the worst bid in the queue).
2. Otherwise, if current node is not a leaf node, starting with the branch whose pivot is closest to q, repeat step 1 for each of the children of current_node only if the following code snippet returns true
3. def expand_child(child: Node, top_n: Queue[Bid]): min_dist=distance(q, child.pivot)−child.radius net_basis_bound=child.best_basis−freight*min_dist return top_n.size( )<top_n.max_len or net_basis_bound>=top_n.last

It is assumed in this example that Note that freight costs are proportional to distance. This assumption can be relaxed as long as net_basis_bound remains a valid upper bound on net basis.

In order to achieve network efficiency and improve response time, it is desirable to send as few lanes (origin/destination pairs) as to the transport pricing service and Geo-API as possible. In addition, it is desirable to make as few service calls as possible in order to minimize connection setup and teardown costs.

In order to minimize the number of service calls, bids in each explored leaf node are batched to be sent to the transport pricing service and Geo-API. In addition, it is possible to increase the leave node size in order to increase the number of lanes per batch while minimizing the number of batches. However, this approach reduces the efficacy of the ball tree in minimizing the total number of requests. An alternative approach is to aggregate several leaf nodes before sending a request.

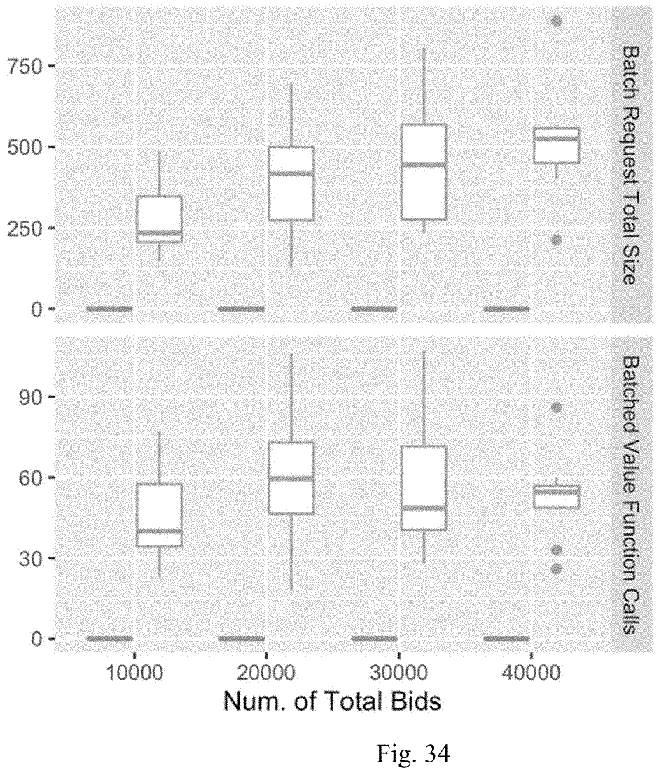

Referring to FIG. 34, a box plot is provided, showing the number of lane quotes and service calls for an exemplary search for the top 20 bids. This shows that the ball tree scales well with bid pool size.

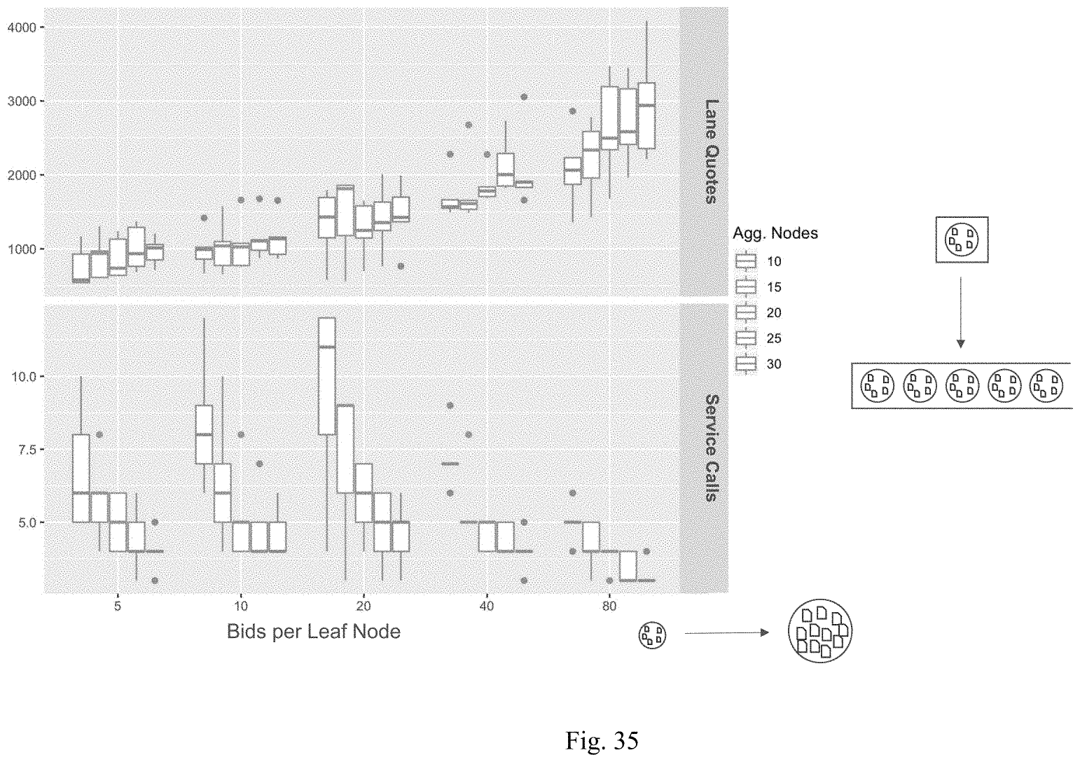

Referring to FIG. 35, a box plot is provided of various configurations of bids per leaf node and aggregated nodes per request. The boxes are grouped based on the number of bids per leaf node as indicated on the horizontal axis. Within each group, boxed correspond to 10, 15, 20, 25, and 30 aggregated nodes from left to right. Looking to the leftmost group, corresponding to 5 bids per leaf node, it will be apparent that a batch of 30 aggregated nodes provides the highest performance. In particular, in this exemplary search for the top 20 bids, the 1000 lanes (at approximately 0.65 msec per lane) and 3 service calls (at approximately 100 msec per call) yields approximately one second of time required with 5 bids per leaf node and 30 aggregated nodes. Accordingly, it is preferable to have small leaf nodes and aggregate them into bigger batches.

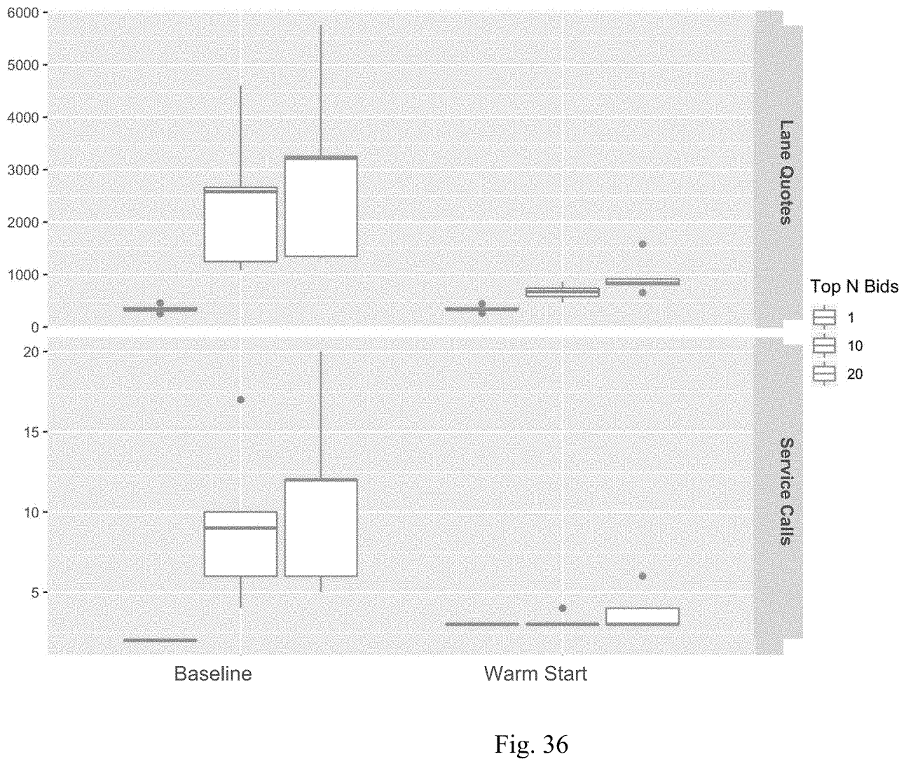

In various embodiments, in addition to node aggregation, a warm start optimization is provided. In an exemplary warm start search, the top N*K bids are determined using only FOB^{H}. By using the heuristic value in place of actual FOB, faster approximate results are obtained. The actual FOB value is then computed for those N*K bids. The resulting bids are sorted, and the top Nth bid is selected as the starting point for the ball tree search. Referring to FIG. 36, it will be appreciated that warm starting cuts down the search significantly, especially for N≥10. Within each group of boxes, the boxes are organized by increasing N from left to right.

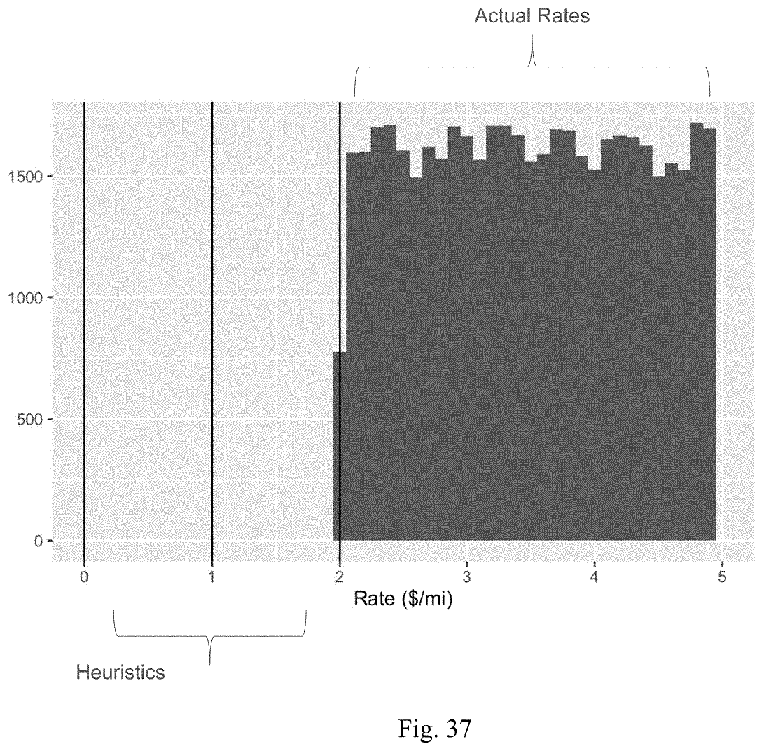

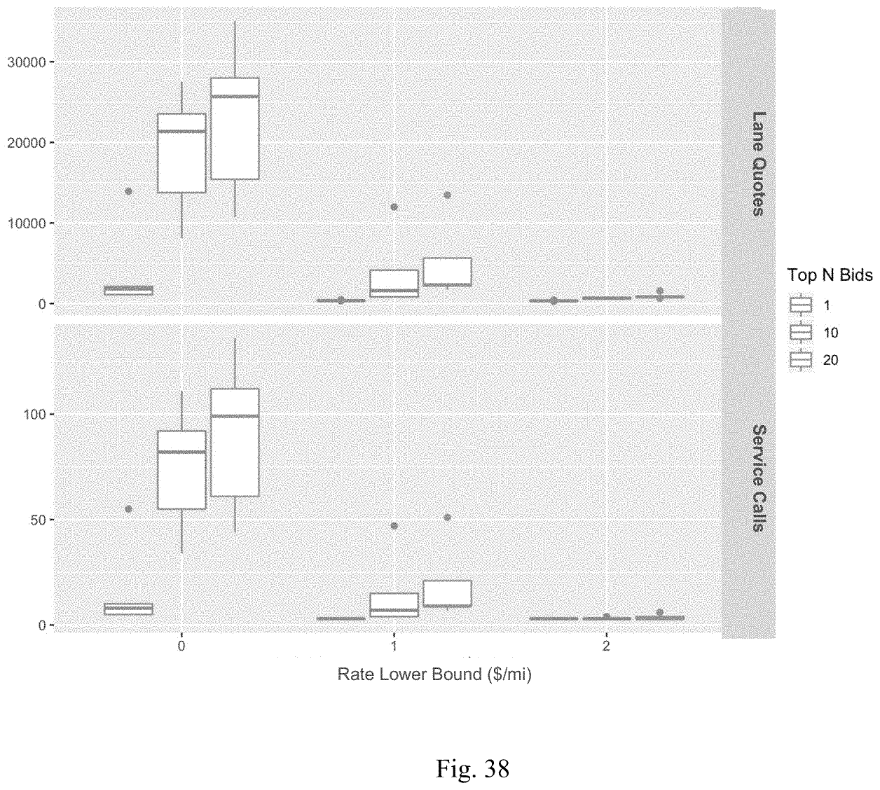

Referring to FIG. 37-38, exemplary heuristic freight rates are illustrated. FIG. 37 shows an exemplary uniform distribution of actual freight rates over the range [2,5]$/mi. Lower bounds 0, 1, and 2 $/mi are adopted as heuristics. In FIG. 38, the number of lane quotes and service calls is illustrated for each of the lower bounds. Within each group of boxes, the boxes are organized by increasing N from left to right. It will be appreciated that a lower bound of 0 results in a greater number of unnecessary quotes and calls, while a tighter lower bound results is significant increase in performance. It will also be appreciated that a lower bound may be predetermined for a given region according to historic or current values with a low cost sort of existing rates.

In an exemplary embodiment of a decorated ball tree, 45k bids can be held in approximately 250 MB of memory. Bid tree construction takes approximately one minute. A constructed tree can be serialized and stored for reinstantiation.

In various embodiments, a ball tree is refreshed on a schedule as new bids become available.

In various embodiments, dist^{H} is given by the haversine distance. In various embodiments, rate^{H} is provided as a static value. In various embodiments, rate^{H} is provided by a transportation rate service that provides a lowest rate of any active rate cards. In various embodiments, rate^{H} is provided by a transportation rate service that provides a lowest rate for any rate card with a given origin and delivery window.

In various embodiments, the net basis is computed by sending the lanes to the transportation rate service (to perform rate card matching) in parallel with sending the lanes to a Geo-API for road-distance measuring. The net basis is then computed for each of the relevant grower/bid pairs.

To demonstrate the performance of the ball tree, a series of experiments was performed in which random samples of bids were taken (ignoring crop and futures reference) and a query point was randomly selected from all bids. The average time to retrieve the top 10 bids using the following three different algorithms was then measured:
1. Baseline 1: The basic algorithm of sorting all bids by net basis and selecting the top 10.
2. Baseline 2: The enhancement where we use a double-ended priority queue for keeping the top 10 bids as we traverse the list.
3. Ball Tree: The decorated ball tree algorithm (excluding construction time).

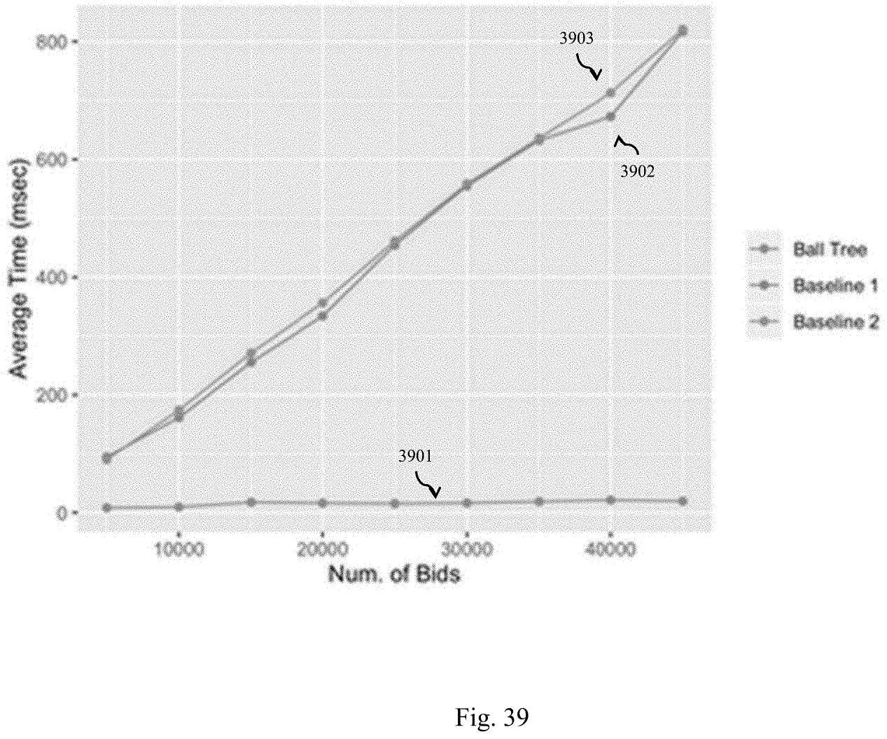

A graph of the average time relative to number of bids is provided in FIG. 39. In all cases, distances were calculated using the Haversine formula. The results show that, once a ball tree is constructed and loaded into memory, it is very efficient and can retrieve the top N bids in O(log(B)) time, regardless of the number of available bids, a significant improvement over O(B) time. The lines are depicted as follows: Ball Tree 3901; Baseline 1 3902; Baseline 2 3903.

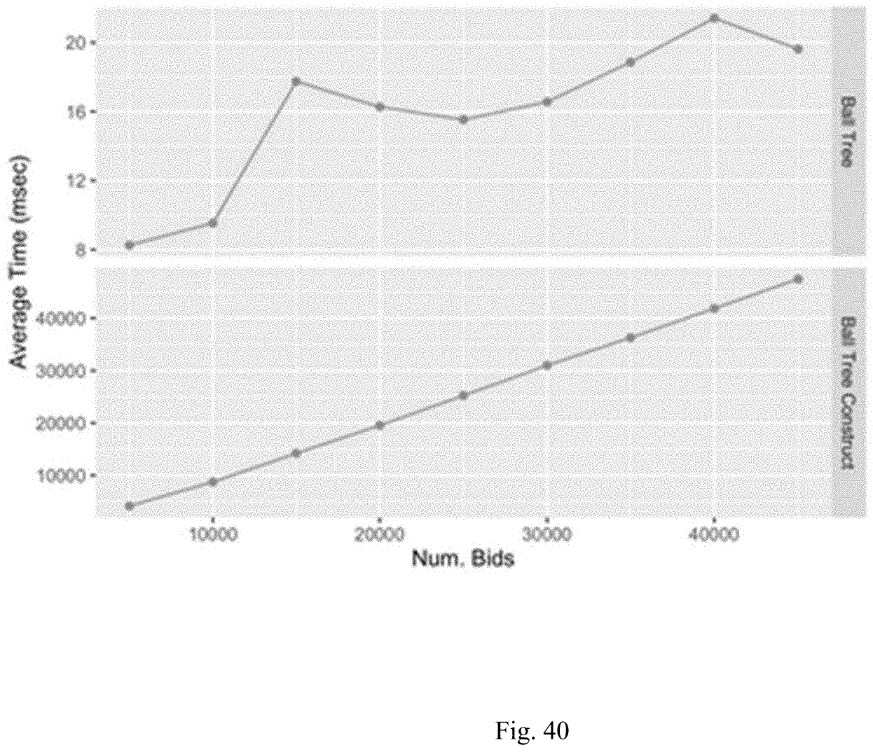

Referring to FIG. 40, a plot is provided showing querying time (top panel) and the construction time (bottom panel) as a function of the number of bids using the decorated ball tree algorithm. It will be appreciated that once the tree is constructed (which takes about 50 sec in the worst case), queries can be done on demand (since they take less than 20 msec).

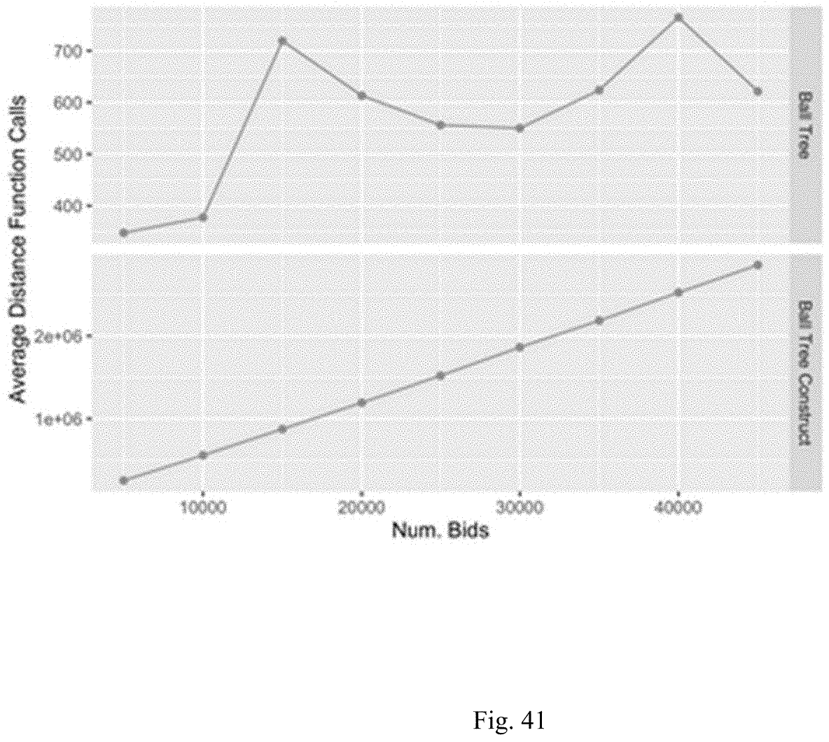

Since the above time estimates are based on being able to compute road distances through a hard-coded formula, it is instructive to look at the number of calls made to the distance function (each function call returns the distance for one pair of points). FIG. 41 shows that, for the case of 45 k bids, the ball tree construction requires calculating distances for about 3M pairs. However, querying for the top 10 bids only required about 650 calls to the function (which contrasts with the 45 k calls required by the baseline algorithm).

As set out above, the ball tree implementation relies on a distance function and a value function to find the best bids (in this case, the value function returns a bid's net-of-transport value for a given grower and bid pair). These functions are called at different times during the construction and exploration of bids in the ball tree. It is thus helpful to distinguish between two types of calls: Heuristic Calls for Non-Leaf Nodes, used to determine if a given branch should be explored; and Batch Calls for Leaf Nodes, used to evaluate all the actual bids in a leaf node, which can be sent in a batch.

Heuristic calls need not return the exact distance or freight cost, as long as they return a lower bound on these quantities. On the other hand, batch calls do need to return the correct net basis. Thus, separate implementations for the heuristic and the batch functions may be provided to ensure an efficient exploration of the bids. Accordingly, in various embodiments, a haversine approximation and a lower bound on rate cards is used for the heuristic calls, while actual road distances and rate cards are used for the batch calls.

The advantage of this approach is that the number of batch calls needed is typically much lower than the number of heuristic calls.

To analyze the performance of this approach, a random subset of actual bids was taken, and then the top 20 bids for a randomly chosen grower location were sought. The number of calls to each function are broken down by calls made during index construction and calls during query.

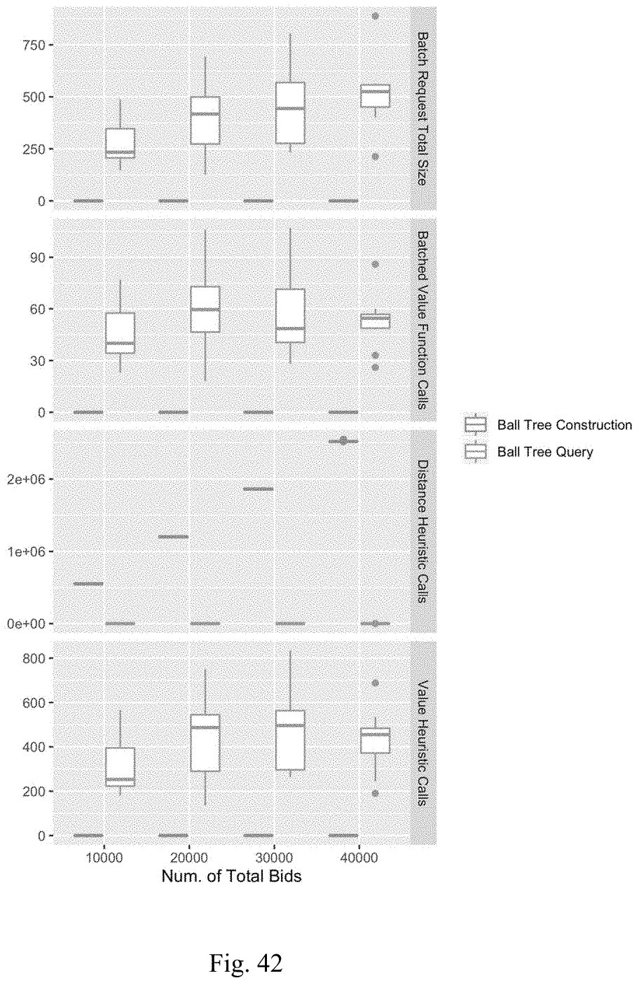

A ball tree leaf node size of 10 is initially provided. Referring to FIG. 42, the first plot shows the total number of bids that were evaluated using batch calls, which is in the order of 500. The second plot shows how many times the batch function was called—an average of about 50. Thus, we would need to call the rate function 50 times with about 10 bids on each request. On the other hand, the heuristic is called about 500 times during query. It is important to note that these numbers are optimistic because the same heuristic and value function is used in this example; in reality, the heuristic will provide a lower bound on distance and freight costs, and if this lower bound is loose, more nodes will be explored. The batch requests (both in number of calls and request size) remains fairly flat as the number of bids is scaled. In each panel of FIG. 42, the boxes corresponding to Query appear above the boxes corresponding to Construction, except the Distance Heuristic panel, in which the boxes corresponding to Construction appear above the boxes corresponding to Query.

The relative number of heuristic and batch calls can be controlled by adjusting the minimum number of bids per leaf in the ball tree (the ball tree leaf node size). A larger node size would give a shallower tree, where fewer batch calls are sent but each batch request will have a larger number of bids. As the ball size increases, more points are evaluated in each batch request, but fewer calls are also made to this function (an asymptote of about 25 batch function calls is reached at ball sizes of 80 or greater). The total query time increases more slowly and stayed below 30 sec for ball sizes of 80. In an exemplary case using 45,000 matching open bids, using a ball size of 80, about 25 calls to the rate function would be required, with a total of 1250 lane quotes. Assuming each service request has an overhead of 100 msec (independent of request size), plus 0.65 msec per lane, about 3.3 sec would be required to find the top 20 bids in this scenario.

As set out above, in various embodiments a transport pricing service is used to manage rate cards configured by users. This allows carriers to set their quotes ahead of time. These rate cards can then be used for directly quoting growers. It is important that this service is able to retrieve rate cards and find the most appropriate rate for a lane efficiently and at scale. Multiple services and tools, including those described above rely on these rates for the appropriate evaluation and comparison of bids, an evaluation that often requires calculating freight costs for hundreds or thousands of grower-buyer pairs in a very short amount of time.

Two categories of approaches for retrieving all relevant rate cards and finding the optimal match for a given lane(s) are provided herein. The first category relies on a spatial database (e.g., PostGIS), while the second category relies on custom data structures such as those described above in connection with efficiently retrieving bids. By residing fully in memory, these structures reduced the time to retrieve the rate cards significantly, while incorporating evolving business logic that would be otherwise hard to incorporate using a GIS database.

For the purposes of the following analysis, the approaches are compared against performance metrics under some assumptions about the expected scale of the transport pricing service. The table below states these metrics, as well as their targets and assumed scale for testing (metrics are ranked in order of descending importance).

| Metric | Description | Target | | Assumed Scale |
|---|---|---|---|---|
| Best rate retrieval time for | Given an origin and N locations, find | <1 | sec | N = max |
| one origin and N | the best rates for each of the | | | num of |
| destinations | associated lanes | | | active bids |
| | | | | in a 500 mi |
| | | | | radius |
| | | | | 5 k unique |
| | | | | rate cards |
| Memory footprint | Host memory needed to store any | <300 | MB | 5 k unique |
| | indexes or data structures for | | | rate cards |
| | retrieval | | | |
| Rate card | Time taken after updating a rate card | <40 | sec | 5 k unique |
| create/update/delete time | and before any indexes or data | | | rate cards |
| | structures are ready to use with the | | | |
| | new data (note: assumed | | | |
| | asynchronous) | | | |
| Minimum rate retrieval | Given an origin and an area, return a | <100 | msec | 5 k unique |
| time from an origin to | lower bound on the best rate for | | | rate cards |
| points within a given area | delivering to any point within the | | | |
| | area. This query would help speed up | | | |
| | associated “find-best-bid” queries. | | | |

Rate card matching can be implemented using a spatial database query. The following pseudo-code sketches such a query, ignoring for illustration purposes some of the requirements (the carrier base rate, lead time adjustments, and capacity constraints are not incorporated in this query, but it will be appreciated that they can be added). The query can be broken down into the following steps:
1. For each carrier, find the rate card that contains the quoted lane's origin and destination point. By construction, there will be at most one rate card satisfying these assumptions.
2. Find any rate adjustments for this rate card that overlap with the lane's delivery window.
3. Select the highest adjusted rate for each carrier.

The next step is to use a carrier rates table to find the best rate for the lane of interest. The query sorts rate cards from best to worst. In case this table is empty, a standard rate may be substituted.

To test the spatial database approach, random mock data were generated as follows. The number of carriers and the number of rate cards per carrier was fixed. The geographical space of interest was fixed to a square with side length of 5,000 mi. Each origin/destination region of a rate card was obtained by: choosing a region centroid (independently) by sampling uniformly from the geographical square; creating a circle with a radius uniformly distributed between the range of 5 to 200 mi; and approximating the circle as a polygon with 64 edges. Rates for each rate card were sampled uniformly from the range of 3 to 5 $/mi (carrier margins were not modeled). Time periods were modeled at the week level (as integers). The start time of each rate card was obtained by sampling from a uniform distribution in the range of 0 to 52. The duration of each rate card was sampled uniformly from the range of 4 to 24 weeks. Lanes were generated by sampling the origin, destination, and delivery window using the same distributions. Carrier ratings were randomly sampled from the set {0, 1}.

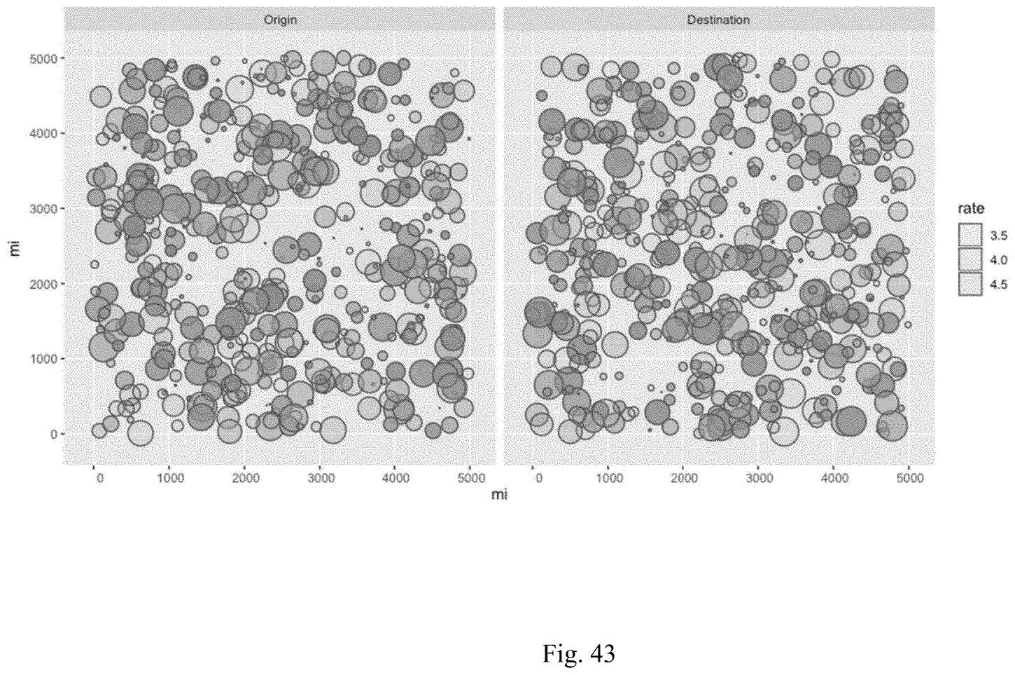

For illustration, FIG. 43 shows the origin and destination zones for a random sample of 500 rate cards. Rate cards are colored by their carrier id and the intensity of the color is proportional to the assigned rate.

A local instance of PostGIS was used to run all queries. The following assumptions were made. The concepts of carrier base rates or adjustments to a rate card were not modeled. However, rate cards of a given carrier to overlap were allowed to overlap. For a given lane and carrier pair, the highest rate among all overlapping rate cards of that carrier was always chosen. The time to compute a default rate was not modeled for lanes that did not match with any rate cards and rate card timestamp tie-breaking. Before running the matching, all lanes to quote were loaded into a temporary table in the database. The time for loading these data was recorded. Gist indexes were used for all geometry columns. No indexes were used for the date ranges. Interaction with the database (uploading and retrieving data) was done exclusively through Python, using SQLAlchemy.

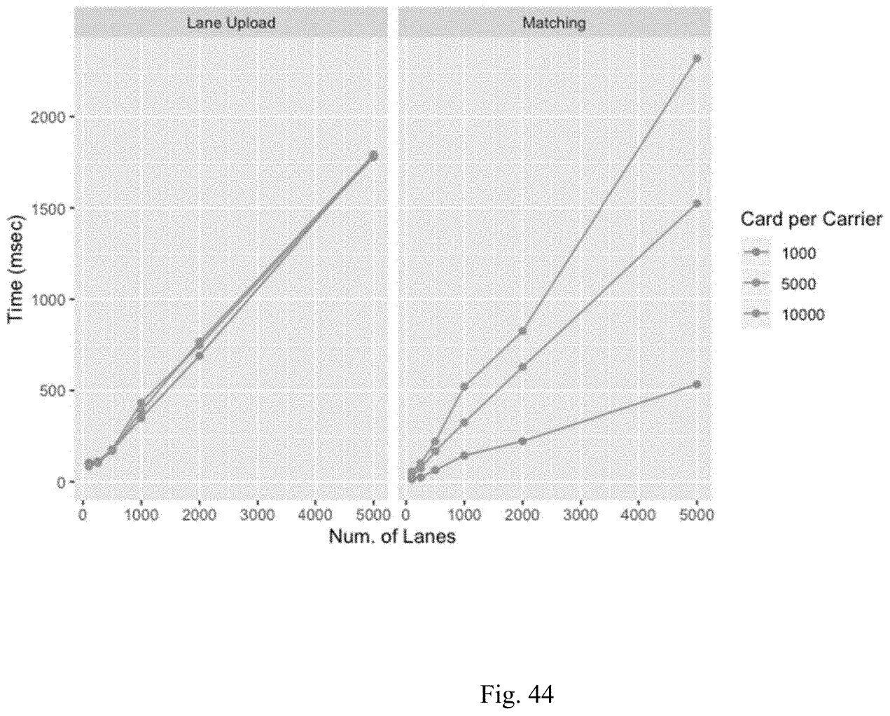

Referring to FIG. 44, the results show the time in milliseconds for retrieving the best matches for different numbers of lanes and rate cards per carrier. Lane Upload refers to the time it took to upload all query lanes into a table in the database, while Matching refers to the time it took to run the query and retrieve in memory the resulting quotes.

A main drawback of the database approach is the potential for increased latency, particularly in cases where this service must quote a large number of lanes in a short amount of time in order to run calculations such as finding the top bids net-of-transport for a given grower. Thus, alternate approaches are provided relying on custom, in-memory data structures that holds the rate cards and allows for very fast retrieval.

For the purposes of this discussion, a RateCard contains a rate and a series of adjustments for date ranges that are contained by the rate card's date range. It is assumed that, for each carrier, there is exactly one rate card with is_base=True, and this rate card contains (spatially and temporally) all other rate cards for the carrier. Rate cards of a given carrier with is_base=False are disjoint (but do not necessarily partition the space enclosed by the carrier's base rate card).

In a first exemplary custom-index variant, sequential matching is employed. In the sequential matching approach, all the rate cards are stored in a list. When given a Lane instance to match, all the rate cards are traversed, checking if the rate card overlaps, and if it does capture the carrier's rate. The best rate among all rate cards is returned, being careful about always preferring a custom rate (if it exists) over the base rate for each carrier and giving preference to high-performance carriers (carrier.rating=1). In some embodiments, overlaps checking, which could be expensive, is only performed if the rate can improve the current best rate.

In a second exemplary custom-index variant, independent attribute indexing is employed. In this approach, the lane's origin, destination, and delivery windows are matched independently against the corresponding attributes of the rate cards. Each attribute matching returns a set of rate cards. The intersect of the sets is taken to find all rate cards that match all attributes. Finally, those rate cards are processed according to the sequential matching method described above.

The independent matching can be done efficiently using indexes. For example, determining if lane.origin is contained in the rate_card.origin can be done efficiently if all the rate card origin geometries (more specifically, their bounding boxes) are stored in an R-tree, and similarly for the other dimensions. It is assumed that RTree has a contains method that returns a list of all geometries stored in the index which contain the given point, and the concept of a geometry is generalized to also include a time interval (used for comparing time range inclusion).

Once all potentially matching rate cards are found, they are passed to the sequential matching method described above to perform an accurate overlap query (using the actual geometry) and find the best rate.

This approach can store the geometries in an R-Tree data structure. Because it is only testing inclusion against bounding boxes, these can be done very efficiently, and once the set intersection is complete, there will at most 2 matching rate cards per carrier (one base and one custom rate).

In a second exemplary custom-index variant, full indexing is employed. In this approach, a custom index is constructed that allows the search procedure to consider all attributes at once. This can be done using an approach similar to k-D Trees, where attributes are alternated as different branches of the tree are explored, and where each node of the tree splits the geometries bounding boxes. Furthermore, if the nodes of the trees are decorated with the best possible rate for each branch, the search could be pruned even further.

The construction of this index relies on an Entry class, that maps to a rate card and that contains three Extent instances. These instances form the bounding boxes of the origin, destination, and date ranges. A binary tree is defined that is referred to as KDRTree, and that uses bulk loading for splitting the entries according to the branching dimension corresponding to each node. This dimension alternates between the 3 dimensions (origin, destination, time) based on the depth of the node.

Searching for lane inclusion in the KDRTree involves going down the nodes of the tree (starting at the root) and testing inclusion of the node's extent for the corresponding dimension against the lane's corresponding attribute. Branches where the inclusion test fails are pruned and entries are only returned from visited leaf nodes.

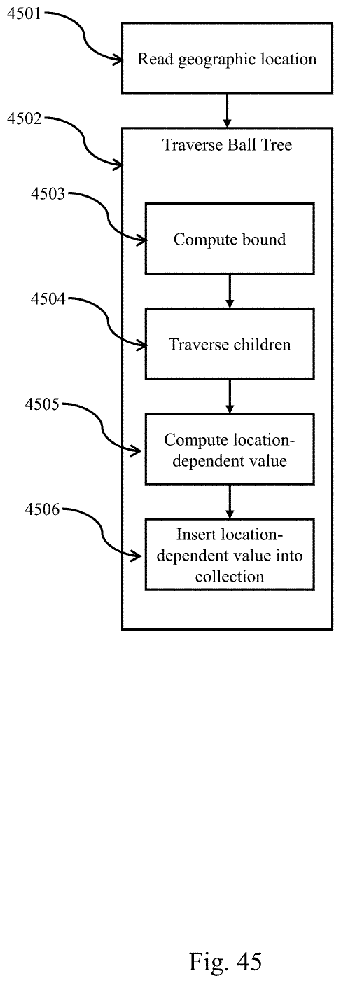

Referring to FIG. 45, a method of sorting location-dependent values is illustrated. At 4501, a first geographic location is read. At 4502, a ball tree is traversed. The ball tree comprises a plurality of nodes, each node of the ball tree comprising a pivot geographic location and a radius, each node corresponding to at least one local value having a location within the radius of the pivot. Traversing the ball tree comprises: at 4503, computing a bound on the location-dependent value for at least one node of the ball tree based on its corresponding at least one local value, its pivot geographic location, and the first geographic location, and at 4504, selectively traversing at least one child of the at least one node according to the bound. At 4505, the location-dependent value is computed for the at least one child based on its corresponding at least one local value, its pivot geographic location, and the first geographic location. At 4506, the location dependent value of the at least one child is inserted to a sorted collection having a predetermined size.

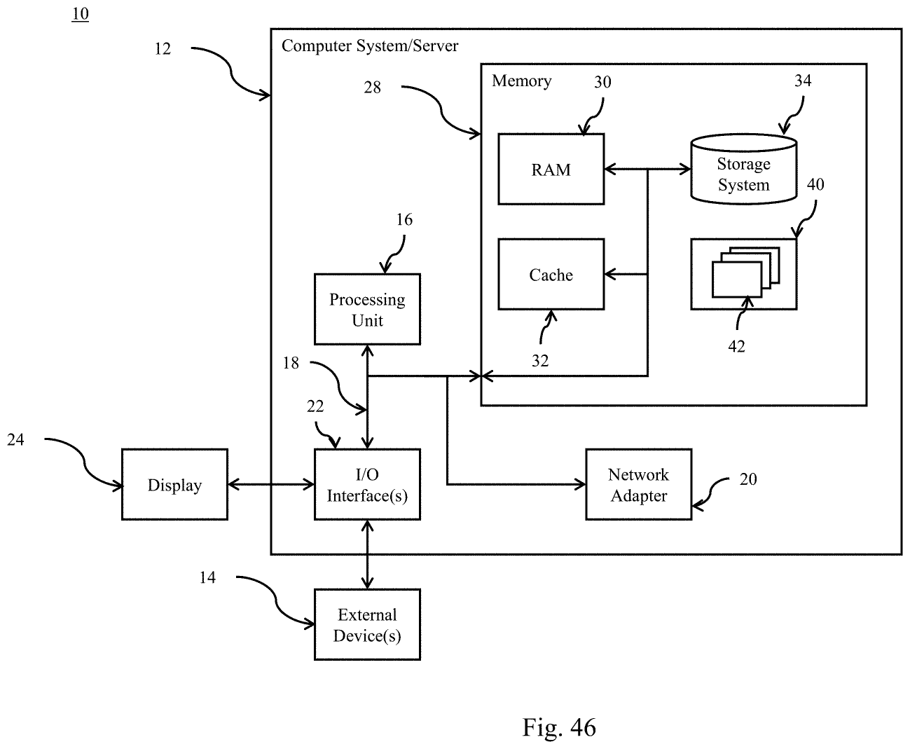

Referring now to FIG. 46, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 46, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The figures depict various embodiments for purposes of illustration only. One skilled in the art will readily recognize from the following discussion that alternative embodiments of the structures and methods illustrated herein may be employed without departing from the principles described herein. Persons skilled in the relevant art can appreciate that many modifications and variations are possible in light of the above disclosure. For example, while reference is made to the transportation of crop products, in practice the methods of interaction described herein can apply equally to objects, goods, commodities, or products other than crop products (e.g., non-agricultural goods or products). Likewise, the methods of transportation of goods described here can apply equally to transportation by means of truck, rail, ships, etc.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus or system for performing the operations herein. Such an apparatus or system may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may include information resulting from a computing process, where the information is stored on a non-transitory, computer readable storage medium and may include any embodiment of a computer program product or other data described herein.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of sorting location-dependent values, the method comprising:
reading a first geographic location;
traversing a ball tree, the ball tree comprising a plurality of nodes, each node of the ball tree comprising a pivot geographic location and a radius, each node corresponding to at least one local value having a location within the radius of the pivot, wherein traversing the ball tree comprises:
computing a bound on the location-dependent value for at least one node of the ball tree based on its corresponding at least one local value, its pivot geographic location, and the first geographic location,
selectively traversing at least one child of the at least one node according to the bound;
computing the location-dependent value for the at least one child based on its corresponding at least one local value, its pivot geographic location, and the first geographic location;
inserting the location dependent value of the at least one child to a sorted collection having a predetermined size.

2. The method of claim 1, wherein the first geographic location corresponds to a grower.

3. The method of claim 1, wherein the location of each local value corresponds to a delivery location.

4. The method of claim 3, wherein each local value correspond to a bid.

5. The method of claim 1, wherein the location-dependent value is a basis net of transport.

6. The method of claim 5, wherein computing the bound on the location dependent-value comprises subtracting a product of an estimated freight rate and an estimated distance between the first geographic location and the location of one of the local values from that local value.

7. The method of claim 6, wherein the estimated freight rate is an estimated lower bound on an actual freight rate.

8. The method of claim 6, wherein the estimated distance is a haversine distance.

9. The method of claim 5, wherein selectively traversing comprises traversing the at least one child when the bound is greater than or equal to a least value in the collection.

10. The method of claim 5, wherein computing the location-dependent value comprises subtracting a product of an actual freight rate and an actual distance between the first geographic location and the location of one of the local values from that local value.

11-15. (canceled)

16. A computer program product for sorting location-dependent values, the computer program product comprising a computer readable storage medium having program instructions embodied therewith, the program instructions executable by a processor to cause the processor to perform a method comprising:
reading a first geographic location;
traversing a ball tree, the ball tree comprising a plurality of nodes, each node of the ball tree comprising a pivot geographic location and a radius, each node corresponding to at least one local value having a location within the radius of the pivot, wherein traversing the ball tree comprises:
computing a bound on the location-dependent value for at least one node of the ball tree based on its corresponding at least one local value, its pivot geographic location, and the first geographic location,
selectively traversing at least one child of the at least one node according to the bound;
computing the location-dependent value for the at least one child based on its corresponding at least one local value, its pivot geographic location, and the first geographic location;
inserting the location dependent value of the at least one child to a sorted collection having a predetermined size.

17. An interface for automated real-time rate card management comprising within a screen of a transportation provider client device:
a map region comprising a user-defined first region having non-zero area contained within the map region,
one or more real-time market demand elements associated with a user-defined region,
a user-editable field containing a base rate for transportation services within the first region calculated automatically upon generation of the first region,
a second user defined region having non-zero area fully-contained within the first region,
a user-editable expiration date field, and
one or more user-editable adjustments fields, where at least one of the one or more adjustments are selected from the list consisting of a seasonal adjustment, an origin adjustment, a destination adjustment, a lead time adjustment, and a quantity adjustment.

18. The interface of claim 17, wherein the interface additionally comprises a third user defined region having non-zero area fully-contained within the first region.

19. The interface of claim 18, wherein the second region is an origin zone and the third region is a destination zone, and wherein the origin zone and the destination zone are a lane.

20. (canceled)

21. The interface of claim 19, wherein the user-editable expiration date field and one or more user-editable adjustments fields contain values associated with the lane.

22. The interface of claim 17, wherein the one or more user-editable adjustments fields are generated automatically based on the creation of the first user defined region or the second user defined region.

23. The interface of claim 17, wherein the interface additionally comprises a plurality of user defined regions fully contained within the first region.

24. The interface of claim 17, wherein the one or more user-defined region is a circle of a user-defined radius around a position within the map region or a shape drawn on map region by the user.

25. (canceled)

26. The interface of claim 17, wherein at least one of the one or more real-time market demand elements are selected from the list consisting of a map layer colored proportionally to market demand, a number of transportation opportunities within one or more user-defined regions, a number or location of transportation opportunities matching user's rate within one or more user-defined regions, a number or location of transportation opportunities within one or more user-defined regions matching the rate of a transportation provider other than the user, a proportion of opportunities within one or more user-defined regions meeting one or more rate parameters, detail of one or more potential transactions within one or more user-defined regions, locations of one or more potential transactions, a number times a user's rate has previously been awarded, a number of goods listed for sale within one or more user-defined regions, and a number of other transportation providers' bids to provide transportation services within one or more user-defined regions.

27. The interface of claim 17, additionally comprising a user-editable field for the minimum or maximum number of loads per week.

28. The interface of claim 17, wherein the second region is a local zone, an origin zone, or a destination zone.

29. The interface of claim 17, additionally comprising display of one or more routes within the map region, wherein the displayed one or more routes begin in the second region, end in the second region, or begin and end in the second region.

30. The interface of claim 29, wherein selection via clicking or tapping the displayed route automatically executes an agreement to provide transportation services.

31. The interface of claim 29, wherein the display of one or more routes includes one or more descriptors for each route selected from the list consisting of a price per mile, a total distance, a commodity type, delivery window, and quantity of goods to be transported.

32. The interface of claim 17, wherein the one or more real-time market demand elements is updated in real-time for the first user defined region, the second user defined region, all user defined regions, or for a lane.

33. (canceled)

34. (canceled)

35. A method for automated real-time rate card management comprising:
receiving from each of a plurality of transportation providers a request to provide transportation services,
displaying a map region on an interface of a client device of each transportation provider,
receiving from each transportation provider via their client device a first region having non-zero area within the map region,
calculating a base rate for providing transportation services within each transportation provider first region and modifying the interface of each transportation provider to display the base rate in a field editable by each transportation provider,
receiving from each transportation provider via their client device a second region having non-zero area contained within the first region,
modifying the interface of each client device to display a real-time indication of market demand within each transportation provider's second region,
in response to receiving the second regions, generating within each interface of a client device of each transportation provider one or more user editable fields including:
an expiration date field, and
one or more adjustment fields, where at least one of the one or more adjustment fields are selected from the list consisting of a seasonal adjustment, an origin adjustment, a destination adjustment, a lead-time adjustment, and a quantity adjustment,
receiving a transportation services opportunity comprising an origin location, a destination location, a price of a good to be transported, and a delivery window,
determining the set of the transportation providers' requests wherein the origin location or destination location of the transportation services opportunity are within the transportation providers' second regions and the transportation providers' expiration date are not before the beginning of the delivery window,
for each transportation providers' request within the set, calculating a custom rate to provide transportation services for the transportation services opportunity based on each transportation providers requests' base rate and adjustments,
updating in real-time an interface of a user of an online crop transaction system with the price of a good to be transported less the cost to transport that good at the lowest calculated custom rate of the transportation providers' request within the set.

36-38. (canceled)
